(19) United States
(12) Patent Application Publication
(10) Pub. No.: US 2004/0257414 A1
(43) Pub. Date: Dec. 23, 2004

(54) Sealed fluidic interfaces utilizing laser welding

(76) Inventors: James D. Anderson JR., Harrodsburg, KY (US); Tim Frasure, Georgetown, KY (US); James A. Kerr, Lexington, KY (US); Steven R. Komplin, Lexington, KY (US); Matthew J. Russell, Stamping Ground, KY (US); Ann M. Trebolo, Nicholasville, KY (US); Jon B. Whitney, Georgetown, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/735,353

(22) Filed: Dec. 11, 2003

Related U.S. Application Data
(63) Continuation-in-part of application No. 10/465,377, filed on Jun. 18, 2003.

(51) Int. Cl. B41J 2/175

(52) U.S. Cl. 347/93; 29/890.1

(57) ABSTRACT

A method of assembling an ink filtration system in fluid communication with an ink source comprising the steps of: (a) providing a printhead base including at least one ink channel in fluid communication with at least one nozzle; (b) positioning an ink filter in fluid communication with at least the one ink channel of the printhead base; and (c) laser welding the ink filter in series with the printhead base to provide a sealed fluidic interface therebetween ensuring that ink within at least the one ink channel has passed through the ink filter. Also disclosed are methods and resulting apparatuses utilizing laser welding to mount components of an ink cartridge for use with an inkjet printer.

### CROSS-REFERENCE TO RELATED APPLICATIONS

This application is a continuation-in-part of U.S. patent application Ser. No. 10/465,377, entitled “SEALED FLUIDIC INTERFACES FOR AN INK SOURCE REGULATOR FOR AN INKJET PRINTER”, filed on Jun. 18, 2003, the disclosure of which is hereby incorporated by reference.

### BACKGROUND

1. Field of the Invention

The present invention is directed to methods, and apparatuses produced from such methods, for securing components of an ink cartridge or a printhead base to one another; and, more particularly, to methods, and apparatuses produced from such methods, for securing an ink filter and/or an ink filter cap to an ink cartridge or a printhead base by utilizing a laser welding process.

2. Background of the Invention

Inkjet printers must take ink from an ink source and direct the ink to the printhead where the ink is selectively deposited onto a substrate to form dots comprising an image discernable by the human eye. An electronic signal is received by a heater chip in proximity to an ink nozzle, causing the heater chip to rapidly increase in temperature for a fraction of a second, thereby causing the ink in proximity to the heater chip to become vaporized. The vaporization of some of the ink causes a pressure differential at the nozzle orifice, thereby driving ink from the nozzle where it is deposited onto the medium. The nozzles incorporated into the printhead provide a very small opening, typically about 12 microns, through which the ink is ejected and must be kept free of particulate matter to avoid clogging the nozzle.

Prior art methods of removing or reducing the particulate matter present in the ink stream reaching the nozzles have involved placing a filter in series with the ink flow. The filter may be a mesh and comprised of a woven metal or fibrous material, as well as polymeric screens. In all instances, the filter is designed to inhibit particulate debris in the ink from reaching the nozzles of the printhead, while enabling ink flow therethrough.

Various locations throughout the ink travel path have been utilized for positioning the ink filter, with the most popular location being adjacent to a conduit funneling the ink flow and reducing the overall cross-section required to be filtered, and in turn, reducing production costs. In the case of a printhead having a standpipe leading out of the ink reservoir and to the nozzles, the ink filter may be mounted onto the top of the standpipe by heating a ram and pushing the ink filter into the standpipe material to create a seal therebetween. However, the dimension of the opening through which the ram must be placed to be aligned with the standpipe and the susceptibility of TAB circuit failure from the radiant heat has played a role in the development of the present invention.

### SUMMARY OF THE INVENTION

The present invention is directed to methods, and apparatuses produced from such methods, for securing components of an ink cartridge or a printhead base to one another; and, more particularly, to methods, and apparatuses produced from such methods, for securing an ink filter and/or an ink filter cap to an ink cartridge or a printhead base by utilizing a laser welding process.

Laser welding utilizes a laser light source to precisely direct laser light onto a medium capable of absorbing the light to heat the medium. Once the medium is heated, in the case of a polymeric substrate, a portion of the medium absorbing the light becomes viscous, and may heat the transparent medium adjacent thereto resulting in a viscous state. Upon cooling, the viscous material solidifies and concurrently bonds the polymeric substrate to other mediums adjacent thereto.

In the present invention, laser light may be directed onto any material capable of radiating the heat resulting from absorbing laser light to an adjacent medium and thereby bonding the mediums together. Laser light may travel through a transparent or translucent medium before being absorbed by an opaque medium. In such a circumstance, the opaque medium may act as a heat conductor to bond the opaque medium to a translucent medium. The terms opaque, transparent, translucent, and absorbing are at the wavelength of the laser light which is not necessarily the same as the visible light wavelengths. An example might include a translucent ink filter cap having a laser pass therethrough and be absorbed by an opaque standpipe of the printhead base. Upon the standpipe becoming elevated in temperature and a portion of the standpipe becoming viscous, the hot viscous standpipe material bonds with the translucent ink filter cap providing a sealed fluidic interface therebetween.

It is a first aspect of the present invention to provide a method of assembling an ink filtration system in fluid communication with an ink source comprising the steps of: (a) providing a printhead base including at least one ink channel in fluid communication with at least one nozzle; (b) positioning an ink filter in fluid communication with at least the one ink channel of the printhead base; and, (c) laser welding the ink filter in series with the printhead base to provide a sealed fluidic interface therebetween ensuring that ink within at least the one ink channel has passed through the ink filter.

In a more detailed embodiment of the first aspect, the ink filter includes a transparent polymer material. In another more detailed embodiment, the ink filter includes an opaque polymer material. In yet another more detailed embodiment, the ink filter includes a metal. In a further detailed embodiment, the metal includes stainless steel. In still a further detailed embodiment, the printhead based includes a standpipe to which the ink filter is mounted thereto. In a more detailed embodiment, the method further comprises the step of laser welding an ink filter cap onto the printhead base. In another more detailed embodiment, the ink filter is between the ink filter cap and the printhead base.

It is a second aspect of the present invention to provide a method of assembling components of an ink filtration system adapted to be associated with an inkjet printer, comprising the steps of: (a) providing a printhead base having at least one ink channel in fluid communication with at least one nozzle; (b) providing an ink filter cap; (c) providing an ink filter interposing the printhead base and the ink filter cap; and, (d) laser welding at least one of the printhead base, the ink filter cap, and the ink filter to at least another of the printhead base, the ink filter cap, and the ink filter to provide a sealed fluidic laser welded joint therebetween.

In a more detailed embodiment of the second aspect, the method further comprises the step of aligning the ink filter with respect to an orifice in the ink filter cap. In another more detailed embodiment, the method further comprises the step of aligning the ink filter with respect to an orifice in a standpipe of the printhead base. In yet another more detailed embodiment, an ink flow regulator is mounted to the ink filter cap. In a further detailed embodiment, the ink filter is mounted to the printhead base in an earlier step, and the ink filter cap is laser welded to the printhead base in a later step. In still a further detailed embodiment, the ink filter is mounted to the ink filter cap in an earlier step, and the ink filter cap is laser welded to the printhead base in a later step. In a more detailed embodiment, the ink filter is laser welded to the ink filter cap in an earlier step, and the ink filter cap is mounted to the printhead base in a later step. In a more detailed embodiment, the ink filter is laser welded to the printhead base in an earlier step, and the ink filter cap is mounted to the printhead base in a later step. In another more detailed embodiment, the ink filter is laser welded to the printhead base in an earlier step, and the ink filter cap is laser welded to the printhead base in a later step. In yet another more detailed embodiment, the ink filter is laser welded to the ink filter cap in an earlier step, and the ink filter cap is laser welded to the printhead base in a later step. In still another more detailed embodiment, the ink filter, the ink filter cap, and the printhead base are mounted together in a single laser welding step.

It is a third aspect of the present invention to provide an ink cartridge comprising: (a) a printhead base comprising a heater chip, the plurality of nozzles, and a TAB circuit; (b) a container adapted to house a reservoir of ink therein, the container having a conduit directing ink within the reservoir toward the plurality of nozzles associated with the printhead base; and, (c) an ink filter laser welded to the container conduit to inhibit particulate debris from entering the conduit.

In a more detailed embodiment of the third aspect, an ink filter cap is mounted to the container conduit. In a further detailed embodiment, the ink filter is positioned between the container conduit and the ink filter cap.

It is a fourth aspect of the present invention to provide a method of assembling components of an ink regulation and filtration system for an inkjet printer comprising the steps of: (a) providing a printhead base having at least one ink channel in fluid communication with at least one nozzle; (b) providing an ink filter in fluid communication with at least the one ink channel of the printhead base; (c) providing an ink flow regulator in fluid communication with at least the one ink channel; and, (d) laser welding at least two of the printhead base, the ink filter, an ink filter cap, and the ink flow regulator together to provide a sealed fluidic interface and ensure that ink within at least the one ink channel has passed through the ink filter before reaching at least the one nozzle.

In a more detailed embodiment of the fourth aspect, the ink filter is laser welded to the printhead base. In another more detailed embodiment, the ink filter cap is laser welded to the printhead base. In yet another more detailed embodiment, the ink filter cap is laser welded to the ink filter. In a further detailed embodiment, the ink filter cap and ink filter are laser welded to the printhead base.

It is a fifth aspect of the present invention to provide a method of mounting an ink filter in fluid communication with a plurality of nozzles associated with a printhead base comprising the step of providing a sealed fluidic conduit between a source of ink and a channel in fluid communication with a nozzle of a printhead base, the sealed fluidic conduit includes an ink flow regulator, an ink filter, and an ink filter cap, where at least one of the ink flow regulator, the ink filter, and the ink filter cap are laser welded to provide the sealed fluidic conduit between the source of ink and the channel in fluid communication with the nozzle of the printhead base.

It is a sixth aspect of the present invention to provide a method of mounting components of an inkjet printer cartridge comprising the steps of: (a) mounting an ink filter to a standpipe of a printhead base; and, (b) mounting an ink filter cap to the standpipe of the printhead base.

In a more detailed embodiment of the sixth aspect, the mounting steps occur concurrently. In another more detailed embodiment, the ink filter is laser welded to the standpipe of the printhead base. In yet another more detailed embodiment, the ink filter is laser welded to the ink filter cap. In a further detailed embodiment, the ink filter is mounted to an inner circumferential ledge of the standpipe that is recessed from an upper circumferential surface onto which the ink filter cap is mounted to the standpipe. In an even further detailed embodiment, the ink filter cap is laser welded to the upper circumferential surface of the standpipe. In an additional detailed embodiment, the ink filter is laser welded to the inner circumferential ledge of the standpipe.

It is a seventh aspect of the present invention to provide a method of mounting components of an inkjet cartridge using a laser welding apparatus, wherein the method includes at least one step from the group consisting of laser welding an ink filter to a printhead base, laser welding an ink filter cap to an ink filter, laser welding an ink filter cap to a printhead base, laser welding an ink filter to an ink flow regulator, laser welding an ink filter cap to an ink flow regulator, laser welding an ink flow regulator to a printhead base, laser welding an ink flow regulator to an ink reservoir conduit, and laser welding an ink filter cap to an ink reservoir conduit.

It is an eighth aspect of the present invention to provide a method of accommodating viscous material flow from a laser welded joint comprising the step of providing a cavity in proximity to a joint into which viscous material resulting from a laser welding process may flow, the cavity being bounded in part by an angled surface not parallel to the direction of flow of the viscous material, where the joint lies on a first plane and the angle between the first plane and the angled surface is greater than 90 degrees.

It is a ninth aspect of the present invention to provide a method of accommodating viscous material flow from a laser welded joint comprising the step of providing a trap available for a viscous material generated from a laser welding process to flow into, the laser welding process mounting at least two components together to form a joint lying on a first plane, where a first cross-sectional area of the trap taken along the first plane is less than a second cross-sectional area attributable to a second cross-section taken along a second plane spaced and parallel to the first plane.

It is a tenth aspect of the present invention to provide a method of accommodating viscous material flow from a laser welded joint comprising the step of providing a cavity in proximity to a joint between a first component and a second component to accommodate a flow of a viscous material from the joint during a laser welding procedure to mount the first component to the second component, the cavity defined in part by a tapered flange unevenly spaced from an opposing wall, where the opposing wall is a constituent of a first component and the tapered flange is a constitute of a second component.

It is an eleventh aspect of the present invention to provide a method of accommodating viscous material flow from a laser welded joint comprising the step of providing an ink filter cap having a flange at least partially circumscribing an outer wall of a standpipe, the ink filter cap contacting the standpipe to form an interface therebetween, the flange being separated from the outer wall of the standpipe to leave a gap into which viscous material may flow from the interface upon application of a laser the interface, where the flange generally includes an angled wall facing the outer wall of the standpipe, and where the distance between the angled wall and the outer wall of the standpipe increases concurrently as the distance between the interface and the angled wall increases.

### BRIEF DESCRIPTION OF THE DRAWINGS

FIG. 1 is a cross-sectional, schematic, first stage representation of an exemplary embodiment of the present invention;

FIG. 2 is a cross-sectional, schematic, second stage representation of the exemplary embodiment of FIG. 1;

FIG. 3 is a cross-sectional, schematic, third stage representation of the exemplary embodiment of FIGS. 1 and 2;

FIG. 4 is an elevational, cross-sectional view of an exemplary embodiment of the present invention;

FIG. 5 is perspective, cross-sectional view of the exemplary embodiment of FIG. 4;

FIG. 6 is an overhead perspective view of a lever component of the embodiments of FIGS. 4 and 5;

FIG. 7 is an underneath perspective view of the lever component of FIG. 6;

FIG. 8 is an elevational, cross-sectional view of the embodiment similar to the embodiments of FIGS. 4-7 mounted within an ink cartridge;

FIG. 9 is an elevated perspective, cross-sectional view of the exemplary embodiment of FIG. 10;

FIG. 10 is a cross-sectional view of an additional exemplary embodiment of the present invention;

FIG. 11 is an isolated overhead view of the ink outlet of the embodiments of FIGS. 9 and 10;

FIG. 12 is an isolated cross-sectional view of the ink outlet of the embodiments of FIGS. 9 and 10;

FIG. 13 is an elevational, cross-sectional view of the embodiment similar to the embodiments of FIGS. 9 and 10 mounted horizontally within an ink cartridge;

FIG. 14 is an elevational, cross-sectional view of the embodiment similar to the embodiments of FIGS. 9 and 10 mounted vertically within an ink cartridge;

FIG. 15 is a perspective, exploded view of another embodiment of the present invention representing an ink cartridge with multiple ink reservoirs and respective ink regulators provided therein;

FIG. 16 is a perspective overhead view of another embodiment of the present invention representing an ink cartridge with multiple ink reservoirs and respective ink regulators provided therein; and

FIG. 17 is an elevational, cross-sectional view of the embodiment of FIG. 16.

FIG. 18 is an exploded view of a third exemplary embodiment of the present invention representing an exemplary mounting for securing an ink regulator to a print head, represented in part by an ink filter cap;

FIG. 19 is a cross-sectional view of another exemplary embodiment of the present invention mounted to a print head;

FIG. 20 is an exploded view of an alternate exemplary embodiment of the present invention representing another exemplary mounting for securing an ink regulator to a print head, represented in part by an ink filter cap;

FIG. 21 is a cross-sectional view of an alternate exemplary embodiment of the present invention mounted to a print head;

FIG. 22 is a perspective, exploded view of some exemplary components that may be utilized in exemplary mounting procedures in accordance with the present invention;

FIG. 23 is an exploded, cross sectional view of an exemplary mounting procedure in accordance with the present invention;

FIG. 24 is an exploded, cross sectional view of another exemplary mounting procedure in accordance with the present invention;

FIG. 25 is an exploded, cross sectional view of yet another exemplary mounting procedure in accordance with the present invention;

FIG. 26 is an exploded, cross sectional view of still another exemplary mounting procedure in accordance with the present invention;

FIG. 27 is an exploded, cross sectional view of still a further exemplary mounting procedure in accordance with the present invention;

FIG. 28 is an exploded, cross sectional view of even a further exemplary mounting procedure in accordance with the present invention;

FIG. 29 is an exploded, cross sectional view of another exemplary mounting procedure in accordance with the present invention;

FIG. 30 is an exploded, cross sectional view of still another exemplary mounting procedure in accordance with the present invention;

FIG. 31 is an exploded, cross sectional view of a further exemplary mounting procedure in accordance with the present invention;

FIG. 32 is an exploded, cross sectional view of still a further exemplary mounting procedure in accordance with the present invention;

FIG. 33 is a cross sectional view of a further exemplary mounting procedure incorporating a tapered trap in accordance with the present invention;

FIG. 34 is a cross sectional view of still another exemplary mounting procedure incorporating a tapered trap in accordance with the present invention;

FIG. 35 is a cross sectional view of an even further exemplary mounting procedure incorporating a tapered trap in accordance with the present invention;

FIG. 36 is an isolated cross sectional view of an exemplary mounting procedure incorporating a tapered trap in accordance with the present invention;

FIG. 37 is an isolated cross sectional view of another exemplary mounting procedure incorporating a tapered trap in accordance with the present invention; and

FIG. 38 is a separated, cross sectional view of a second aspect of the present invention for mounting and sealing a septum within a step of an ink cartridge.

### DETAILED DESCRIPTION

The exemplary embodiments of the present invention described and illustrated below include ink regulators and/or ink cartridges (reservoirs) utilizing such regulators, for regulating the volumetric flow of ink between an ink source and a point of expulsion, generally encompassing a print head. Other exemplary embodiments described and illustrated below include methods, and apparatuses resulting from such methods, directed to mounting components of an ink cartridge or an integrated ink cartridge and printhead. The various orientational, positional, and reference terms used to describe the elements of the inventions are therefore used according to this frame of reference. Further, the use of letters and symbols in conjunction with reference numerals denote analogous structures and functionality of the base reference numeral. Of course, it will be apparent to those of ordinary skill in the art that the preferred embodiments may also be used in combination with one or more components to produce a functional ink cartridge for an inkjet printer. In such a case, the orientational or positional terms may be different. However, for clarity and precision, only a single orientational or positional reference will be utilized; and, therefore it will be understood that the positional and orientational terms used to describe the elements of the exemplary embodiments of the present invention are only used to describe the elements in relation to one another. For example, the regulator of the exemplary embodiments may be submerged within an ink reservoir and positioned such that the lengthwise portion is aligned vertically therein, thus effectively requiring like manipulation with respect to the orientational explanations.

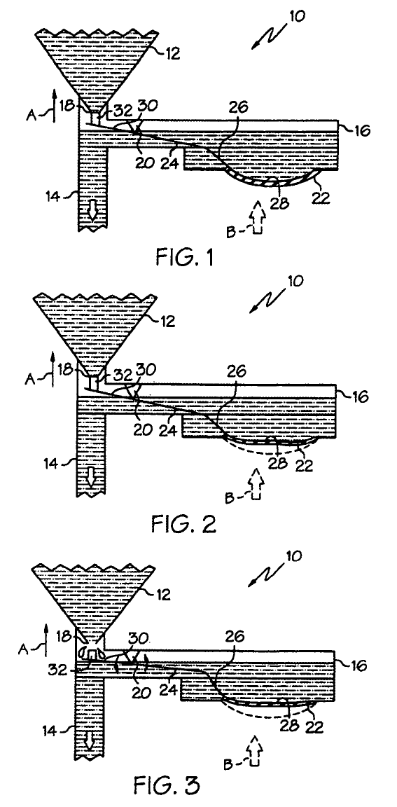

As shown in FIGS. 1-3, an ink regulator 10 for regulating the volumetric flow of ink traveling between an ink source 12 and a print head in fluid communication with an ink outlet 14 generally includes: a pressurized chamber 16 including an ink inlet 18 in fluid communication with the ink source 12, the ink outlet 14 in fluid communication with the print head, and at least one flexible wall 22 or diaphragm; and a lever 24, pivoting on a fulcrum 20, including a flexible arm 26 having a spoon-shaped end 28 extending along a portion of the flexible wall 22 (diaphragm) and an opposing arm 30 operatively coupled to an inlet sealing member 32. The lever 24 is pivotable between a first position as shown in FIG. 1, in which the sealing member 32 presses against the ink inlet 18 to close the ink inlet, to a second position as shown in FIG. 3, in which the sealing member 32 is moved away from the ink inlet 18 to open the ink inlet and allow fluid communication between the ink inlet and the pressurized chamber 16. The lever 24 is biased (as shown by arrow A) to be in the first position, closing the ink inlet 18. The pressure within the pressurized chamber is set to be lower than that of the ambient pressure (shown by arrow B) outside of the flexible wall/diaphragm 22; and, as long as the ink inlet 18 remains closed, the pressure differential along the flexible wall will increase as ink flows through the outlet 14 to the print head. Consequently, a lower pressure differential across the flexible wall 22 causes the flexible wall 22 to expand/inflate and, thereby, pull the spoon-shaped end 28 of the flexible arm 26 contacting the flexible wall to pivot the lever 24 to the first position (closing the ink inlet in FIG. 1). Actually, the bias (represented by arrow A) causes the lever 24 to pivot when the flexible wall 22 no longer applies sufficient force against the spoon-shaped end 28 of the flexible arm to overcome the bias. A higher pressure differential across the flexible wall 22 causes the flexible wall to contract/deflate and, thereby, actuate the flexible arm contacting the flexible wall 22 so as to pivot the lever 24 to the second position (opening the ink inlet 18 as shown in FIG. 3), overcoming the bias (represented by arrow A). Also, when the pressure differential increases from the lower pressure differential to the higher pressure differential across the flexible wall 22 (resulting from ink flowing from the chamber 16 to the print head), the flexible wall 22 is caused to begin contracting/deflating and, thereby, actuate and flex the flexible arm 26 without causing the lever 24 to substantially pivot (as shown in FIG. 2).

The regulator will typically function in a cyclical process as shown in FIGS. 1-3. Referencing FIG. 1, the regulator is mounted to an ink outlet 14, such as a print head, and the inlet 18 is in fluid communication with an ink source 12. Generally, the contents of the chamber 16 will be under a lower pressure than the surrounding atmosphere (represented by Arrow B), thereby creating “back pressure” within the chamber 16. At this stage, the chamber 16 contains a certain amount of ink therein and the closed seal 32 prohibits ink from entering the chamber from the ink source 12, as the pressure differential across the flexible wall 22 is relatively low. The flexible wall 22 is in contact with the spoon-shaped end 28 of the lever's flexible arm 28. The lever is also biased (by a spring, for example) in this closed orientation.

Referencing FIG. 2, as ink continues to leave the chamber 16, the pressure within the chamber 16 begins to decrease, which, in turn, causes the pressure differential across the flexible wall 22 to increase (assuming the pressure on the outside of the flexible wall remains relatively constant). This increasing pressure differential causes the flexible wall 22 to begin to contract/deflate. Because the flexible wall 22 is in contact with the spoon-shaped end portion 28 of the lever's flexible arm 26, this contraction/deflation of the flexible wall causes the lever to flex, but not substantially pivot since the force of the flexible wall against the lever's flexible arm is not yet strong enough to overcome the bias.

Referencing FIG. 3, as ink continues to leave the chamber 16 and further increase the pressure differential across the flexible wall, the flexible wall 22 will contract/deflate to an extent that the inward pressure of the flexible wall against the flexible arm 26 of the lever overcomes the static force of the bias to pivot the lever 24 to its open position, thereby releasing the seal between the seal 32 and the ink inlet 18.

Thus, the bias and the properties of the lever enable the lever 24 to flex first, and thereafter when the amount of force applied to the lever is greater than the force applied by the spring to bias the lever closed, the lever pivots. This relatively high pressure differential between the contents of the chamber and the environment causes ink from the higher pressure ink source to pour into the chamber. The incoming volume of ink reduces the pressure differential such that the flexible wall expands outward from the chamber (inflating) to arrive again at the position as shown in FIG. 1, thus starting the three part cycle over again.

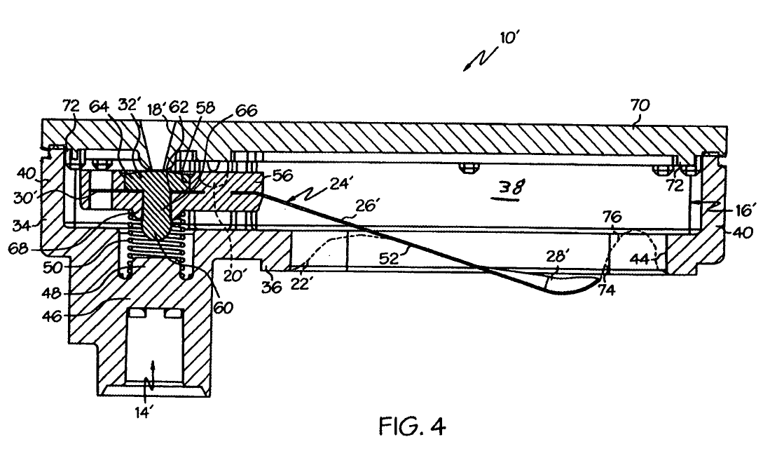

FIGS. 4-7 illustrate an exemplary embodiment of the regulator 10′ for regulating volumetric flow of ink traveling between an ink source (not shown) and a print head in fluid communication with an ink outlet 14′. As introduced above, the regulator 10′ includes a pressurized chamber 16′ having an ink inlet 18′ in fluid communication with the ink source and the ink outlet 14′, which is in fluid communication with the print head (not shown). In this exemplary embodiment, the pressurized chamber 16′ is formed by an injection molded base 34 having a floor 36, a pair of elongated opposing side walls 38 and a pair of elongated opposing end walls 40 which collectively form a generally rectangular top opening bounded by the four interior walls. The elongated side walls each include a pair of vertical ribs forming a bearing seat for receiving bearing pins 42 of the lever 24′, thereby forming the lever's fulcrum 20′.

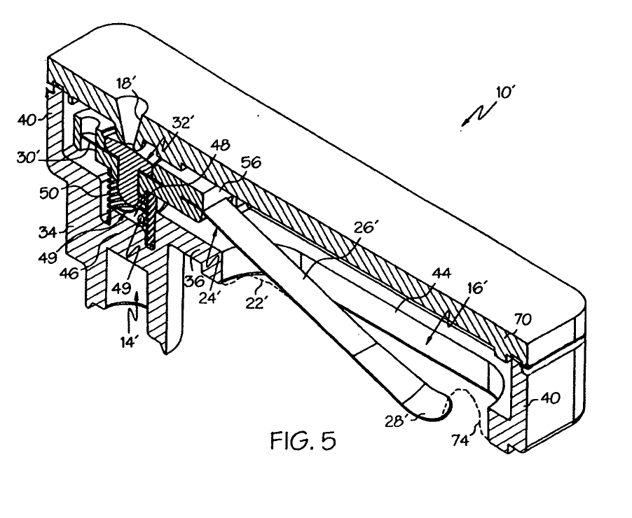

The floor 36 includes a generally cylindrical orifice forming the ink outlet 14′ and a generally oval orifice 44 over which the flexible wall/diaphragm 22′ is mounted. A pair of perpendicular, diametrical spring supports 46 (forming a cross) are positioned within the cylindrical channel of the outlet 14′, where the central hub of the cross formed by the pair of diametrical supports 46 extends upwardly to form an axial projection for seating a spring 50 thereabout. Circumferentially arranges gaps 49 between the supports 46 provide fluid communication between the chamber 16′ and the ink outlet 14′ (see FIG. 5). The spring 50 provides the bias represented by arrow A in FIGS. 1-3.

The lever 24′ includes a strip of spring metal 52 with a spoon-shaped first end 28′ and an encapsulated second end 54. The spoon-shaped end 28′ is angled with respect to the encapsulated end 54. The encapsulated end 54 is encapsulated by a block 56 of plastic material where the block 56 includes the pair of bearing pins 42 extending axially outward along the pivot axis of the fulcrum 20′; and also includes a counter-bored channel 58 extending therethrough for seating an elastomeric sealing plug 60 therein. The strip 52 of spring metal also includes a hole 62 extending therethrough that is concentric with the channel 58 in the encapsulated body 56 for accommodating the sealing plug 60. The plug 60 includes a disk-shaped head 64 and an axial stem 66 extending downwardly therefrom. As can be seen in FIG. 4, the plug 60 is axially aligned with the spring 50, and the encapsulated body 56 is seated within the spring 50 by a dome-shaped, concentric projection 68 extending downwardly from the encapsulated body. The spring metal construction of the strip 52 provides the flexibility of the arm 26′ described above with respect to FIGS. 1-3.

The base 34 is capped by a plastic lid 70 having a generally rectangular shape matching that of the rectangular opening formed by the elongated side walls 38 and end walls 40 of the base 34. The lid 70 has a generally planar top surface with the exception of a generally conical channel extending there through to form the inlet 18′ of the pressurized chamber 16′. The lower side of the lid 70 includes a series of bases or projections 72 for registering the lid on the base 34. In an alternate embodiment, the lid may include a cylindrical tube (coupled to element 71 of FIG. 8, for example), aligned with the inlet 18′ forming a hose coupling. The lid 70, of course, is mounted to the body 34 to seal the chamber 16′ there within.

The flexible wall 22′ is preferably a thin polymer film attached around the outer edges of the oval opening 44 extending through the floor 36 of the base 34. The area of the film 22′ positioned within the opening 44 is larger than the area of the opening 44 so that the flexible film 22′ can expand outwardly and contract inwardly with the changes of the pressure differential between the pressurized chamber 16′ and the outer surface 74 of the film (where the pressure on the outer surface 74 of the film may be ambient pressure, pressure of ink within and ink reservoir, etc.).

Assembly of the regulator includes providing the base 34; positioning the spring 50 on the seat 48; positioning the pins 42 of the lever 24′ within the bearing seats formed in the elongated side walls 38 of the base 34 and seating the dome 68 on the spring 50 such that the spoon-shaped end 28′ of the lever contacts the inner surface 76 of the flexible wall 22′; and mounting the lid 70 thereover so as to seal the pressurized chamber 16 therein. Operation of the regulator 10′ is as described above with respect to the regulator 10 of FIGS. 1-3.

As shown in FIG. 8, the regulator 10′ may be mounted within an ink reservoir 78 of an ink cartridge 80, having a print head 82. The outlet 14′ of the regulator 10′ is coupled to an inlet 84 of the ink filter cap 122 (that is operatively coupled to the print head 82) by an adapter 85. The adapter 85 is mounted to the regulator outlet 14′ and circumscribes a seal 87 that provides a fluidic seal between the adapter 85 and the ink filter cap 122. An collar 86 circumscribes the adapter 85 for additional support. A siphon hose (not shown) provides fluid communication between the lowest point 88 of the reservoir 78 and the hose coupling 71, which is in fluid communication with the regulator's ink inlet 18′. In this embodiment, pressure provided against the outer surface 74 of the flexible wall 22′ will be the pressure within the ink reservoir 78.

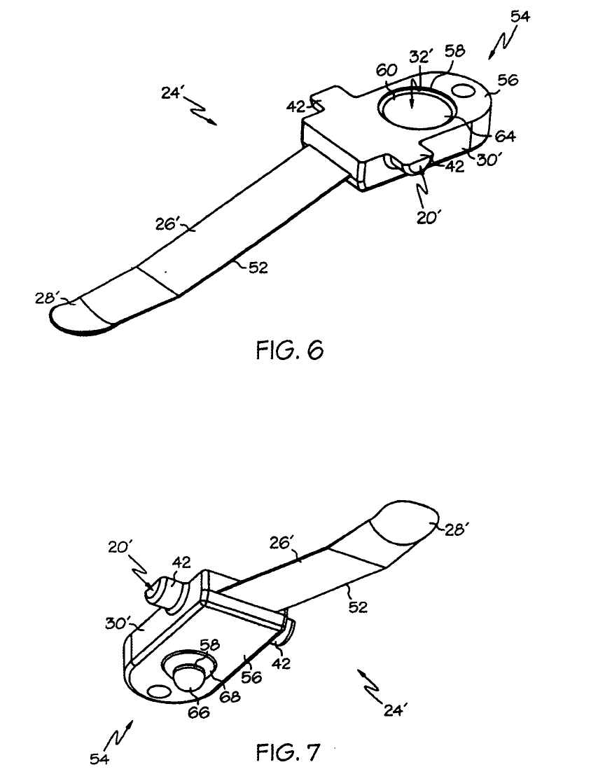

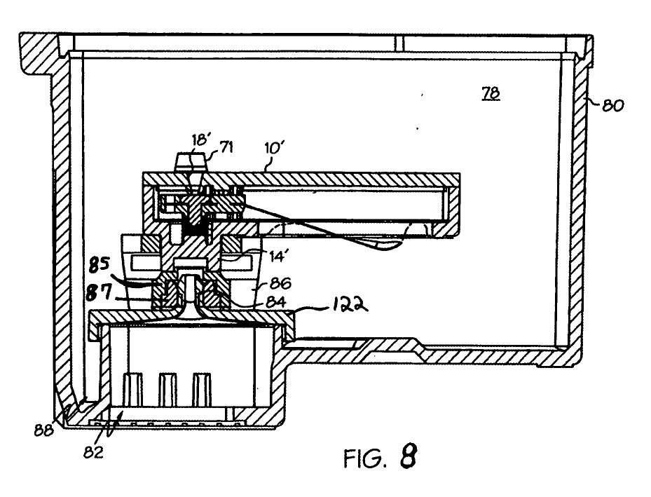

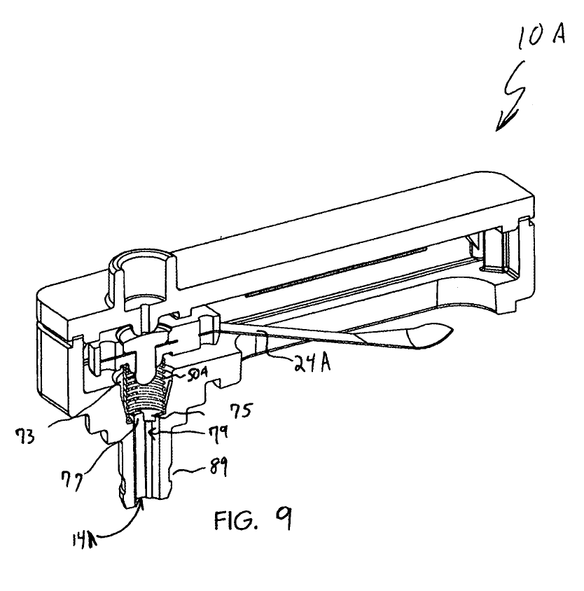

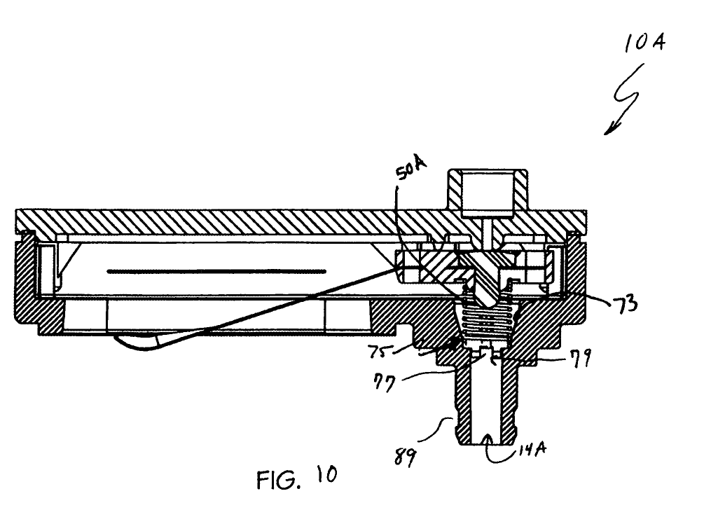

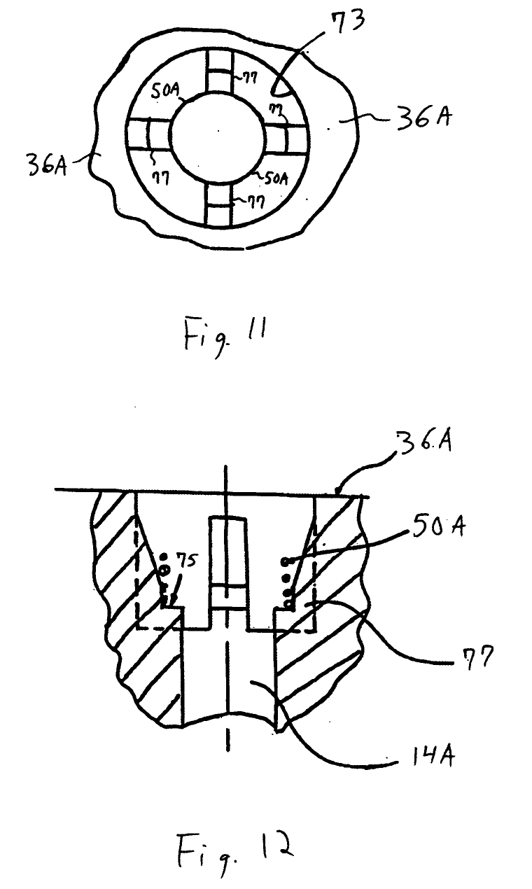

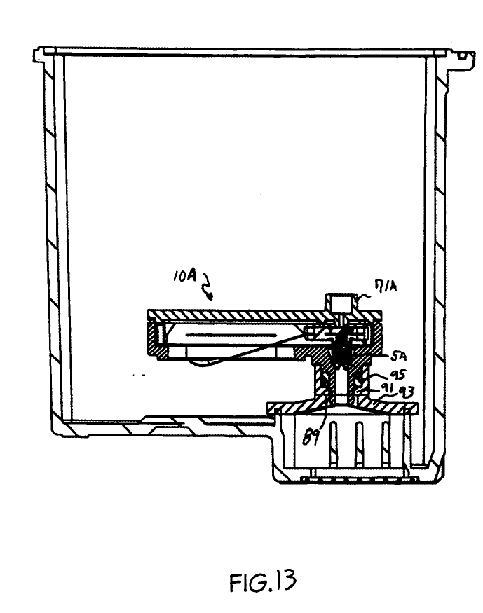

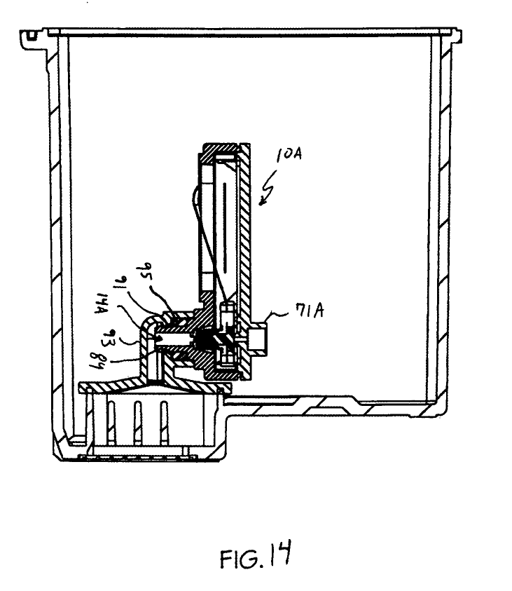

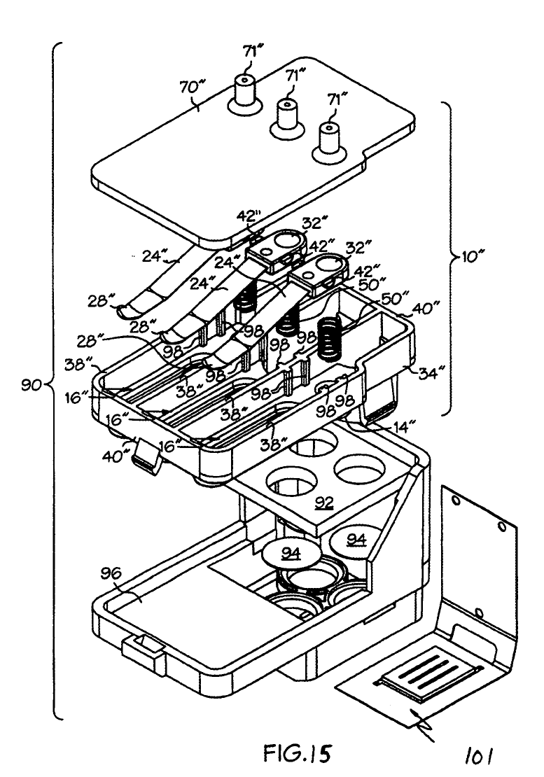

FIGS. 9-12 illustrate another exemplary embodiment of the regulator 10A for regulating the volumetric flow of ink traveling between an ink source (not shown) and a print head (not shown) in fluid communication with an ink outlet 14A. The regulator 10A includes a majority of the same structural features of the regulator 10′ (See FIGS. 4 and 5) discussed above, and may utilize the same lever mechanisms as described above (See FIGS. 6 and 7). However, the regulator 10A of this exemplary embodiment includes a cylindrical opening 73 in the floor 36A in fluid communication that abuts a smaller diameter cylindrical ink outlet 14A (smaller with respect to the cylindrical opening 73), thereby allowing throughput of ink from the pressurized chamber 16A by way of the ink outlet 14A.

The cylindrical opening 73 in the floor 36A includes a spring seat 75 for seating the lower portion of the spring 50A therein. The spring seat 75 includes a plurality of protrusions extending outward from the walls of the cylindrical opening 73 that provide substantially L-shaped ribs 77 (four in this exemplary embodiment) in elevational cross-section. The vertical portion of the L-shaped ribs 77 tapers and transitions inward toward the interior walls to provide a relatively smooth transition between the rib surfaces potentially contacting the spring 50A and the interior walls of the cylindrical opening 73. The horizontal portion of the L-shaped rib 77 provides a plateau upon which the spring 50A is seated thereon. The tapered portions of the ribs 77 work in conjunction to provide a conical guide for aligning the spring 50a within the spring seat 75.

In assembling this exemplary embodiment, the tapered portion of the L-shaped ribs 77 effectively provides a conical guide for aligning the spring 50A within the spring seat 75. In other words, the L-shaped ribs 77 within the cylindrical opening 73 provides ease in assembly as the spring 50A is placed longitudinally approximate the throughput 79 and becomes gravitationally vertically aligned within the opening 73, thereby reducing the level of precision necessary to assembly this exemplary embodiment.

As shown in FIGS. 13-14, the regulator 10A may be mounted within an ink reservoir 78A of an ink cartridge 80A operatively coupled to a print head 82A. The ink outlet 14A of the regulator 10A includes an annular groove 89 on the outer circumferential surface of the outlet stem that is adapted to mate with a corresponding annular protrusion 91 of an adapter 93 to provide a snap fit therebetween. The adaptor 93 extends from, or is coupled to the inlet of the print head 82. The above-described coupling mechanism can thus be used to orient the regulator 10A in a generally vertical manner as shown in FIG. 14, or a generally horizontal manner as shown in FIG. 13. To ensure a sealed fluidic interface is provided between the outlet 14A of the regulator 10A and the adapter 93, an O-ring 95 or analogous seal is circumferentially arranged about the ink outlet 14A radially between the outlet stem and the adaptor 93. Upon snapping the regulator 10A into place so that the annular groove 89 receives the protrusion 91 of the adapter 93, the O-ring 95 is compressed, resulting in a radial compression seal between the adapter 93 and the ink outlet 14A.

A siphon hose (not shown) may be operatively coupled to the ink inlet 18A to by way of the hose coupling 71A to provide fluid communication between a lower ink accumulation point 88A of the reservoir 78A and the ink inlet 18A. While the above exemplary embodiments have been described and shown where the coupling adapter 93 is integrated into, and functions concurrently as a filter cap for the print head 82, it is also within the scope and spirit of the present invention to provide an adapter that is operatively mounted in series between a filter cap of the print head 82 and the regulator 10A.

As shown in FIG. 15, another second exemplary embodiment of the present invention representing a multi-color print head assembly 90 with three ink sources (not shown) and three respective ink regulators 10″ for controlling the volumetric flow of colored inks from the respective ink sources to the tri-color print head 92. Generally, a simple three-color print head will include ink sources comprising yellow colored ink, cyan colored ink, and magenta colored ink. However, it is within the scope of the present invention to provide multi-color print head assemblies having two or more ink sources, as well as single color print head assemblies. Thus, this exemplary embodiment provides a compact regulation system accommodating multi-color printing applications. For purposes of brevity, reference is had to the previous exemplary embodiments as to the general functionality of the individual regulators 10″.

The print head assembly 90 includes a multi-chamber body 34″, a top lid 70″ having three inlet hose couplings 71″ for providing fluid communication with the three ink sources, three levers 24″, three springs 50″, a seal 92, three filters 94, a nose 96, and the tri-color print head heater chip assembly 101. Each chamber 16″ is generally analogous to the chamber described in the previous exemplary embodiments. FIG. 15 provides a view of the vertical ribs 98 provided on the elongated side walls 38″, and optionally on the underneath side of the top lid 70″, providing the bearing seats for the bearing pins 42″ of the levers 24″ as discussed above with respect to the above exemplary embodiments. Further, each chamber includes internal bearing seats, an opening accommodating inward movement of the flexible wall (not shown), and a spring guide (not shown). Likewise, each lever 24″ is analogous to that described in the above exemplary embodiment.

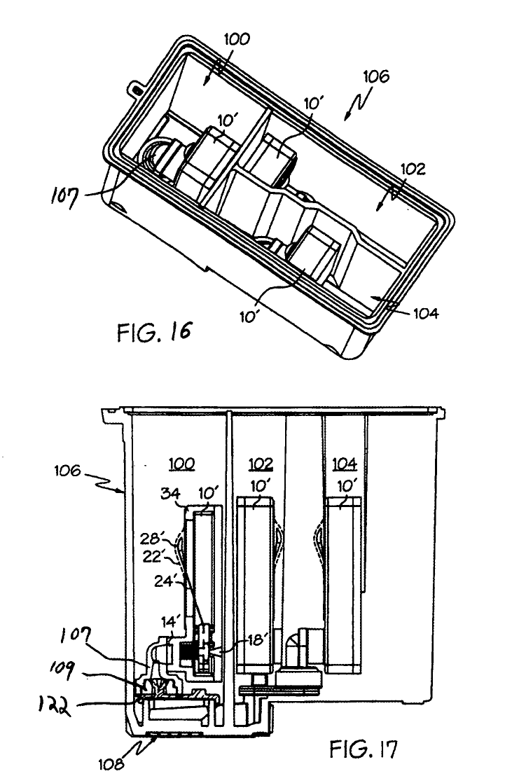

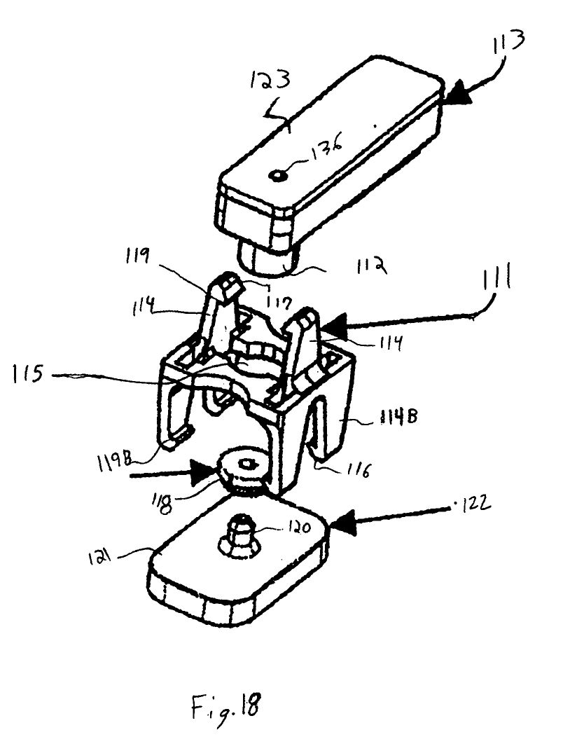

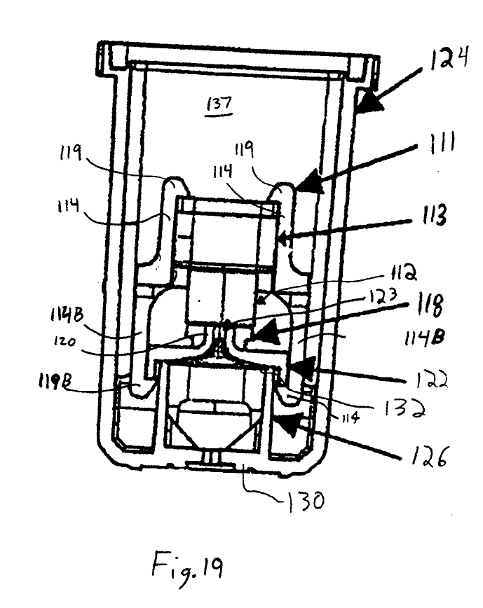

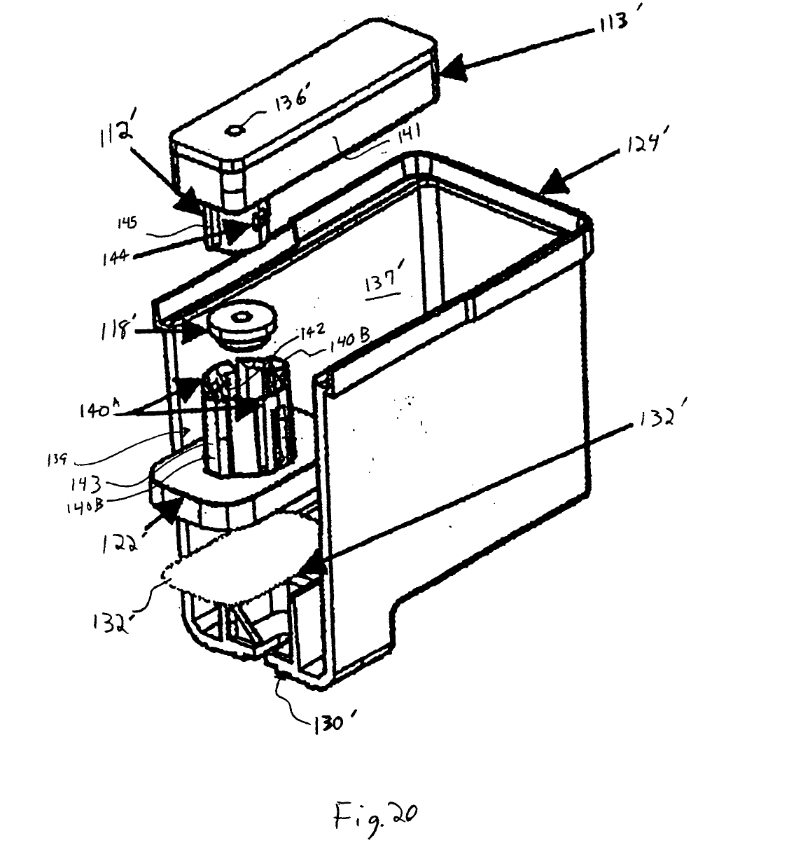

Referencing FIGS. 16 and 17, three of the regulators 10′ are housed within respective ink reservoirs 100, 102 and 104 contained within a multi-color printer ink cartridge 106. The regulators 10′ are generally oriented in a vertical fashion with the ink inlets 18′ and ink outlets 14′ positioned toward the bottom of the respective reservoirs, and the spoon-shaped ends 28′ of the levers 24′ directed upwards. Each of the regulators 10′ includes an adapter 107 that mounts the outlet 14′ of the regulator to the filter cap 122. The ink filter cap 122 is operatively coupled to the print head 108. Each adapter 107 circumscribes a seal 109 that maintains a sealed fluidic interface between the outlet 14′ of the regulator and the inlet 84 of the ink filter cap 122. In such an arrangement it is possible for each of the three respective regulators to function independently of one another, and thus, the fluid level within one of the respective reservoirs has no bearing upon the functional nature of the regulators in the opposing reservoirs. It should also be noted that each of the regulators may include a siphon/hose providing fluid communication between the fluid inlet 18′ and the floor of the respective fluid reservoirs, such that the lower pressure within the fluid regulator is able to draw in almost all of the fluid within a respective chamber. Each of the respective reservoirs provides an individual fluid conduit to the multi-color print head 108 while functioning independent of whether or not the respective regulator is submerged completely within ink, partially submerged within ink or completely surrounded by gas. It should also be understood that this exemplary embodiment could easily be adapted to provide two or more individual fluid reservoirs by simply isolating each respective reservoir having its own individual fluid regulator contained therein and operatively coupled to the regulator such that the ink flow from the reservoir must be in series or must go through the regulator before exiting the respective reservoir.

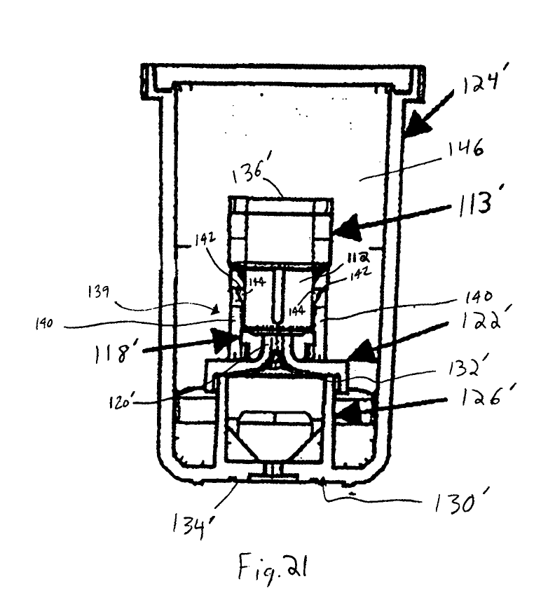

Referencing FIGS. 18 and 19, a next exemplary embodiment of the present invention is directed to a method and apparatus for securing an ink regulator in one of the above exemplary embodiments onto a print head base. As shown in FIG. 18, a retention clip 111 is used to mount an outlet 112 of a regulator 113 to an inlet nipple 120 of a filter cap 122. The retention clip 111 allows for snap-type fitting between the regulator 113 and the filter cap 122. The upper portion of the retention clip includes a pair of spring fingers 114 for retaining the outlet 112 of the regulator 113 within an orifice 115 of the clip 111. As the outlet 112 of the regulator is pressed into the orifice 115, the curved surfaces 117 of the tongs 119 extending from the opposing spring fingers 114 are contacted by the underneath surface of the regulator, thereby pushing the fingers 114 apart and enabling the outlet 112 of the regulator 113 to pierce the orifice 115 within the clip 111. When the top surface 123 of the regulator 113 passes beyond the tongs 119 of the retention clip 111, the spring fingers 114 are biased toward one another thereby locking the ink regulator in place. The lower portion of the retention clip 111 includes two pairs of spring fingers 114B, each of which include tongs 119B for retaining the inlet nipple 120 of the filter cap 122 approximate the orifice 115 and in engagement with the outlet 112 of the regulator 113. As the filter cap 122 is pressed into engagement, the curved surfaces 116 of the tongs 119B are contacted by the top surface 121 of the filter cap, thereby pushing the fingers 114B apart and directing the nipple 120 approximate the orifice 115. When the bottom surface of the filter cap 122 passes beyond the tongs 119B, the spring fingers 114B snap back toward one another to secure the filter cap 122 in place. An annular seal 118 carried on the nipple 120 abuts the underneath surface of the ink outlet 112 when the filter cap 122 is snapped into the retention clip 111, and, in turn, the regulator 113.

As shown in FIG. 19, a cross-sectional view of an exemplary embodiment is shown such that the fluid regulator 113 is operatively coupled to a print cartridge 124, where the print cartridge also includes a print head base 130 seating a print head assembly 126 therein. The upper spring fingers 114 of the retention clip 111 operatively lock the ink regulator 113 in place and allow for the outlet of the fluid regulator 113′ to abut the seal 118 providing for a sealed fluidic connection between the outlet 112 of the regulator 113 and the nipple 120 protruding from the filter cap 122. The sealed fluidic connection ensures a sealed fluid path for ink to flow between the inlet 136 of the regulator 113 and the outlet of the print head assembly 126. A systematic flow of ink passes out of the regulator 113 and into the opening in the ink filter cap 122, where it passes through the ink filter 132 and delivered to the print head assembly 126.

It is also within the scope of the invention to provide a siphon hose (not shown) operatively coupled to the inlet 136 of the fluid regulator 113 (see FIG. 18). The open end of the hose not coupled to the inlet 136 may be positioned at the bottom level of the ink reservoir 137 to maximize the consumption of ink within the reservoir. Alternatively, the open end of the hose not coupled to the inlet 136 may be coupled to an alternate ink source, such as an ink conduit in fluid communication with a remote ink reservoir.

It is further within the scope and spirit of the present invention to provide a mounting clip (such as a clip similar to the retention clip 111) that mounts an inlet of an ink regulator to an outlet of an ink cartridge (such as an ink tank) that is remote from a print head base. Such an exemplary embodiment may be typified as an off-carrier type of embodiment.

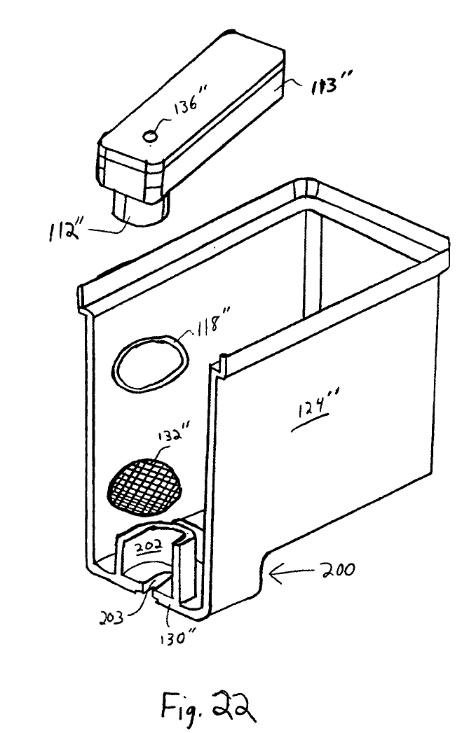

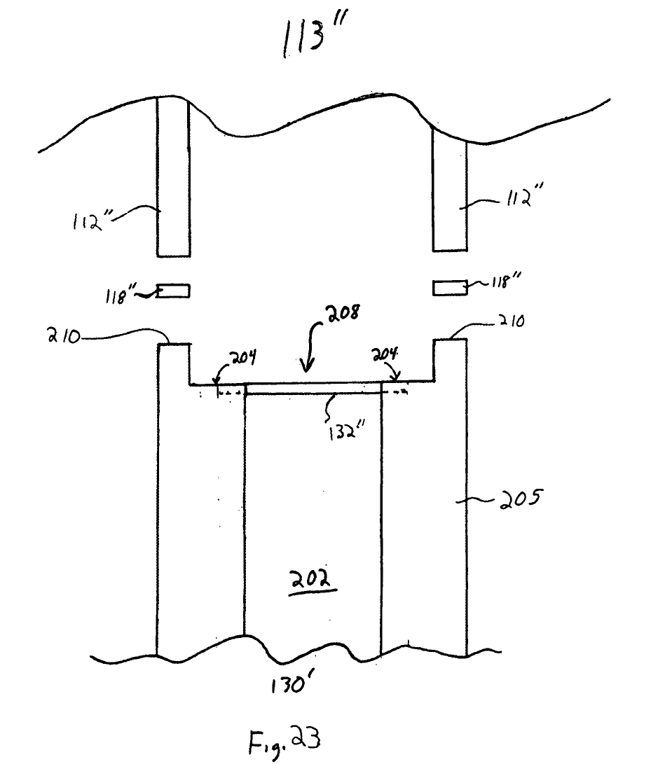

As shown in FIGS. 20 and 21, in a next alternate exemplary embodiment, a retention clip 139 is essentially integrated into the filter cap 122′. The integrated clip 139 secures the outlet 112′ of the fluid regulator 113′ to the ink filter cap 122′, sandwiching therebetween the seal 118′. The integrated retention clip 139 includes a plurality of spring fingers 140 circumferentially arranged around, and coaxial with the nipple 120′ of the filter cap 122′. Two spring fingers 140A each include a recess 142 on an axial inner surface for receiving a corresponding tab 144 extending radially out from the circumferential side surface of the regulator outlet 112′. Two other spring fingers 140B each include an axially extending channel 143 on a radially inner surface for receiving a corresponding axially extending rib 145 extending radially out from the circumferential front and back surface of the regulator outlet 112′. The top surfaces of the spring fingers 140A and the lower surfaces of the tabs 144 are angled such that application of pressure by the tabs 144 against the top surfaces of the spring fingers causes the spring fingers to spread apart to allow the tabs to pass thereby and into the recesses 142. Concurrently, while the spring fingers 140A are engaged with the side surfaces 141 of the regulator 113′, the ribs 145 are being pressed into the channels 143 to supplement angular alignment of the outlet 112′ of the regulator 113′. As the tabs 144 pass into the recesses 142, the spring fingers 140A snap back into place securing the tabs 144 within the recesses 142, and in turn, securing the outlet 112′ to the filter cap 122′.

Referencing FIG. 21, a fluidic seal is developed between the outlet 112′ of the regulator 113′ and the inlet to the nipple 120′ of the ink filter cap 122′. The seal 118′ is concurrently seated around the periphery of the outlet 112′ of the regulator 113′ to provide a first seal, and carried circumferentially around the nipple 120′ to provide a second seal with respect to the filter cap 122′, effectively sandwiching the seal therebetween. In sum, a sealed fluid conduit is provided between the ink within the reservoir 137′ that enters the regulator 113′ through an ink inlet 136′ and the ink that is directly available to the print head assembly 126′, passing through the outlet 112 of the regulator and into the conduit within the nipple 120′, thereafter being filtered by an ink filter 132′. Further, the ink inlet 136′ may include a siphon hose (not shown) providing access to ink otherwise not directly available, for instance, a remote ink reservoir such as an ink tank.

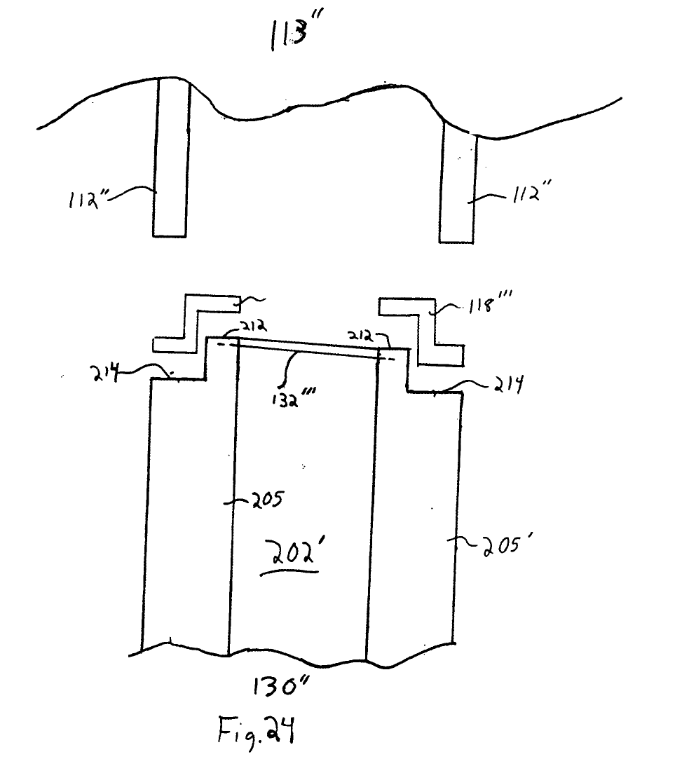

Referencing FIG. 22, an exemplary procedure and assembly has been developed for providing a sealed fluidic channel between an outlet 112″ of an ink regulator 113″ and a print head base 130″ operatively coupled to a print cartridge 124″. The components of this exemplary procedure include the print head base 130″, a filter 132″, an O-ring seal 118″, and the regulator 113″. The print head base 130″ may further comprise features such as, without limitation, a heater chip, nozzles, a TAB circuit, ink channel(s) or stand pipe(s), and additional filter attachment features. In this exemplary procedure, the screen mesh filter 132″ is mounted to a semi-annular standpipe 202 that is located within a recessed area 200 of the print head base 130″. The standpipe 202 includes a throughput 203 for ink to flow to respective nozzles (not shown). To install the ink filter 132″, the standpipe 202 is heated to soften the standpipe material, and the ink filter 132″ is pressed downward onto the standpipe such that the periphery of the filter is pressed into the inner circumferential walls of the standpipe and secured thereto as the standpipe material cools and hardens again. A resultant “wetting ring”, discussed in more detail below (see FIG. 23, “204”), is created and provides a relatively smooth interface with which the seal 118″ may be mounted thereto to provide a sealed fluidic interface. The ink regulator 113″ is pressed into location to align the circumferential area of the outlet 112″ with the circumferential area of the seal 118″ ensuring a proper fluidic seal therebetween. The regulator is secured in place to sandwich the seal 118″ between the outlet 112″ of the regulator 113″ and the “wetting ring” to facilitate a sealed fluidic interface between the inlet 136″ of the regulator 113″ and the throughput 203 of the standpipe 202, with the throughput 203 being in sealed fluid communication with one or more nozzles (not shown) of the print head 130″. It is important to note that seal 118″ may be flat, stepped, and/or contoured (round, oval, etc.).

Referencing FIG. 23, a cross sectional view is shown having the filter 132″ mounted to a recessed, annular top surface 204 of the vertical walls 205 of the standpipe 202. The standpipe walls 205 are heated to transition the material of the standpipe walls from a solid to a viscous/gelatinous state into which the filter 132″ is impressed, causing a portion of the standpipe wall 205 material passes through the filter 132″. The standpipe material that flows through the filter 132″ retains the general interior perimeter shape of the standpipe walls 205 and occupies a portion of the voids (not shown) in the filter, thereby circumscribing and sealing at least a portion of the filter 132″. The standpipe material flowing through the filter forms a wetting ring on the annular top surface 204 that circumscribes the opening 208 through which ink is able to pass, while a relatively smooth surface 210 is provided on a raised portion of the standpipe walls 205 for mounting the seal 118″ thereto to achieve a sealed fluidic interface.

The seal 118″ is likewise mounted to the outlet 112″ of the ink regulator 113″. Thereafter, the outlet of the ink regulator 113″, the seal 118″, and the standpipe 202 are compressed and mounted to one another to provide a fluidic seal therebetween. An adapter 107, as shown in FIGS. 16 and 17, may likewise be mounted to the outlet 112″ of the ink regulator 113″ and concurrently coupled to the seal 118″ to position the ink regulator 113″ in a generally horizontal or vertical fashion. Exemplary techniques for mounting the ink regulator 113″, the seal 118″, the adapter 107, and the standpipe 202 include, without limitation, heat staking, impulse sealing, laser welding, and adhesive bonding, snap-fitting. An exemplary seal material for use in the above procedure includes ethylene-propylene-diene-monomer rubber.

It is also within the scope and spirit of the present invention to provide the recessed surface 204 on the outlet 112″ of the ink regulator 113″. In such an exemplary embodiment, the filter 132″ is recessed within the outlet 112″ of the regulator 113″ while concurrently maintaining the relatively smooth outer circumferential surface of the outlet 112″ with which the seal 118″ may be sandwiched between the outlet 112′ and the standpipe 202 at a relatively smooth surface 210 to provide a fluidic seal utilizing one or more of the above exemplary procedures.

Referencing FIG. 24, it is also within the scope and spirit of the present invention to provide an elevated inner annular top surface 212 and a recessed outer top surface 214 on the walls 205′ of the standpipe 202′. In such an exemplary embodiment, the filter 132′″ is coupled to the inner annular top surface 212 and the seal 118′″ is contoured (stepped) to mate with the surfaces 212, 214 of the standpipe and provide a fluidic seal between the standpipe 202′ and the regulator 113″. Such a contoured seal 118′″ may include a wall structure (not shown) incorporated therein that effectively encapsulates the filter 132′″. The use of a contoured type of “extended seal” may remove the need for insert filters and further protect against cross-contamination. Likewise, it should be understood that the seal 118′″ need not be stepped, but simply provide a sealed fluidic interface between the regulator 113′″ and the surface 214.

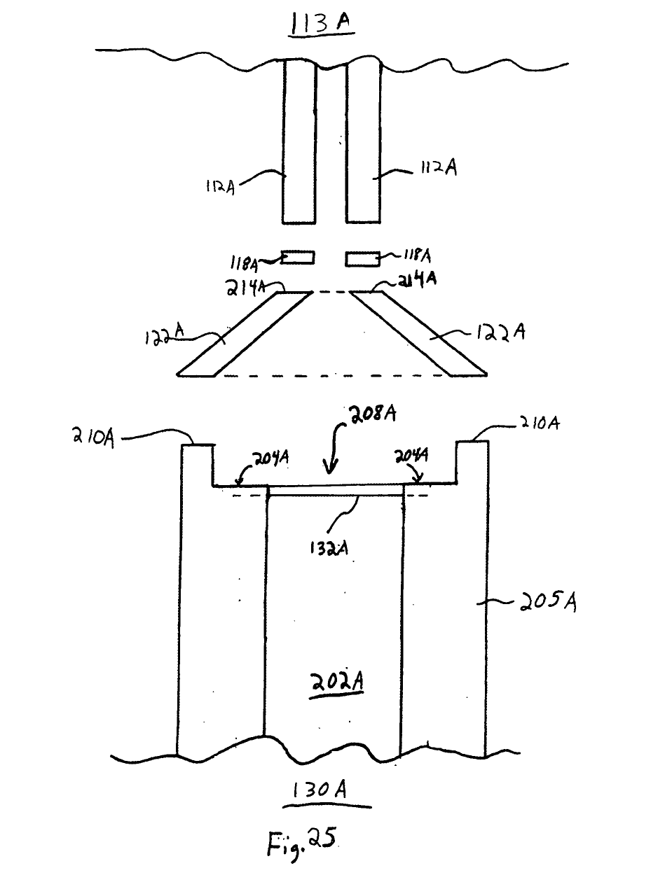

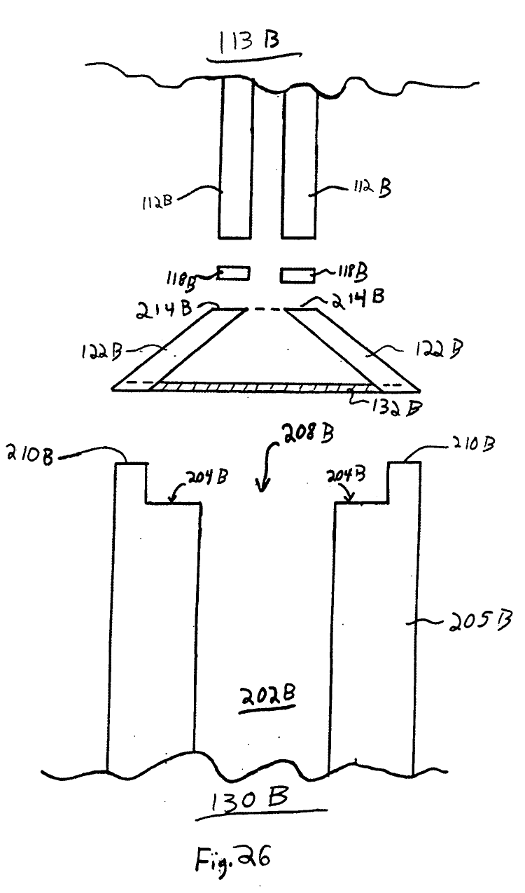

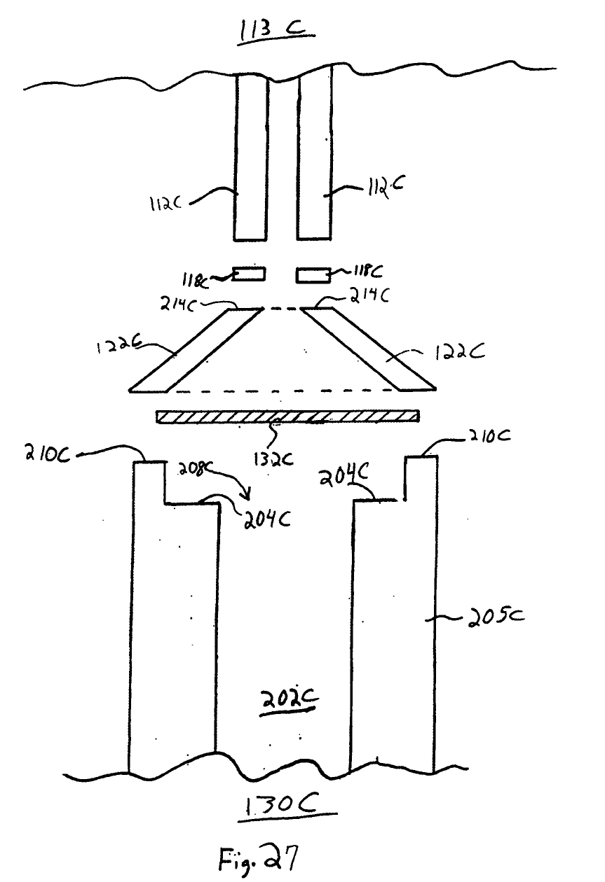

As shown in FIG. 25, a further exemplary procedure for providing a sealed fluidic channel between the ink regulator 113A and the opening 208A of the standpipe 202A includes mounting a filter cap 122A intermediate the regulator outlet 112A and the standpipe 202A. The components of this exemplary procedure include the print head base 130A (represented in part by the standpipe 202A), a filter 132A, a sealing material 118A, and the regulator 113A. The print head base 130A may further comprise features as discussed above, such as, without limitation, nozzles and heater chips. Such an exemplary procedure may utilize one or more of the bonding techniques discussed above. In this exemplary procedure, the filter 132A may be attached to a recessed inner circumferential area of the standpipe 202A upon heating the inner circumferential area resulting in a “wetting ring”. A preferred method includes laser welding the filter cap 122A to the outer circumferential smooth surface 210A of the standpipe 202A to create a sealed fluidic interface therebetween. However, an analogous method includes mounting the filter cap 122A to the recessed area 204A of the standpipe walls 205A to create a sealed fluidic interface between the filter cap 122A and the standpipe walls 205A.

A seal 118A is positioned between the outlet 112A of the ink regulator 113A and an interface 214A of the ink filter cap 122A, with the interface 214A including a flat or contoured surface to mate with the flat or contoured seal 118A. Thereafter, the outlet 112A of the ink regulator 113A, the seal 118A, and the ink filter cap 122A are compressed and mounted to one another to provide a fluidic seal therebetween. An adapter 107, as shown in FIGS. 16, and 17, may likewise be mounted to the outlet 112A of the ink regulator 113A and concurrently coupled to the seal 118A to position the ink regulator 113A in a generally horizontal or vertical fashion. Exemplary techniques for mounting the ink regulator 113A, the seal 118A, the adapter 107, and the ink filter cap 122A include, without limitation, heat staking, impulse sealing, laser welding, ultrasonic welding, snap fit, press fit, friction welding, vibration welding, hot plate welding, and adhesive bonding A resultant sealed fluidic channel for ink to flow is ensured between the inlet of the regulator 113A and the opening 208A of the standpipe 208A of the print head base 130A.

Referencing FIG. 26, yet another exemplary procedure for providing a sealed fluidic channel between the ink regulator 113B and the opening 208B of the standpipe 202B includes mounting a filter cap 122B intermediate the regulator outlet 112B and the standpipe 202B. The components of this exemplary procedure include the print head base 130B (represented in part by the standpipe 202B), a filter 132B, a filter cap 122B, a seal 118B, and the regulator 113B. The print head base 130B may further comprise features as discussed above, such as, without limitation, nozzles and heater chips. In this procedure, the filter 132B may be heat staked to a recessed inner surface of the filter cap 122B, with the filter cap 122B being laser welded to the recessed inner top surface 204B or top surface 210B of the standpipe 202B to ensure a fluidic seal therebetween. Those of ordinary skill are familiar with the requisite techniques for mounting the above-referenced components and may include, but are not limited to, heat staking, impulse sealing, laser welding, ultrasonic welding, and adhesive sealing.

A seal 118B is positioned between the outlet 112B of the ink regulator 113B and an interface 214B of the ink filter cap 122B. Thereafter, the outlet of the ink regulator 113B, the seal 118B, and the ink filter cap 122B are compressed and mounted to one another to provide a fluidic seal therebetween. Still further, an adapter 107, as shown in FIGS. 16, and 17, may likewise be mounted to the outlet 112B of the ink regulator 113B and concurrently coupled to the seal 118B to position the ink regulator 113B in a generally horizontal or vertical fashion. As stated above, exemplary techniques for mounting the ink regulator 113B, the seal 118B, the adapter 107, and the ink filter 122B include, without limitation, heat staking, impulse sealing, laser welding, ultrasonic welding, snap fit, press fit, friction welding, vibration welding, hot plate welding, and adhesive bonding. A resultant sealed fluidic channel is ensured for ink to flow between the inlet of the regulator 113B and the opening 208B of the standpipe 208B of the print head base 130B. It should also be noted that the filter 132B may be positioned on the inlet side of the filter cap 122B without departing from the scope and spirit of the present invention.

Referencing FIG. 27, still another exemplary procedure for providing a sealed fluidic channel between the ink regulator 113C and the opening 208C of the standpipe 202C includes mounting a filter cap 122C intermediate the regulator outlet 112C and the standpipe 202C. The components of this exemplary procedure include the print head base (represented in part by the standpipe 202C), a filter 132C, a filter cap 122C, a seal 118C, and the regulator 113C. The print head base 130C may further comprise features as discussed above, such as, without limitation, nozzles and heater chips. In this procedure, the stainless steel ink filter 132C is concurrently mounted to the filter cap 122C and the standpipe 202C. The filter 132C and filter cap 122C may be attached to a recessed inner annular top surface 204C of the standpipe 202C to ensure a fluidic seal therebetween. Likewise, as shown, the filter cap 122C and filter 132C may be laser welded to the outer annular top smooth surface 210C of the standpipe 202C. It is preferred to have a portion of the filter cap 132C directly bond to the outer annular top smooth surface 210C of the standpipe 202C, without sandwiching the filter 132C therebetween. Those of ordinary skill are familiar with the requisite techniques and may include, but are not limited to heat staking, impulse sealing, laser welding, ultrasonic welding, and an adhesive.

A seal 118C is positioned between the outlet 112C of the ink regulator 113C and an interface 214C of the ink filter cap 122C. Thereafter, the outlet of the ink regulator 113C, the seal 118C, and the ink filter cap 122C are compressed and mounted to one another to provide a fluidic seal therebetween. As stated above, exemplary techniques for mounting the ink regulator 113C, the seal 118C, the adapter 107, and the ink filter cap 122C include, without limitation, heat staking, impulse sealing, laser welding, ultrasonic welding, snap fit, press fit, friction welding, and adhesive bonding. A resultant sealed fluidic channel is ensured for ink to flow between the inlet of the regulator 113C and the opening 208C of the standpipe 208C of the print head base 130C.

It is likewise within the scope and spirit of the present invention to mount the fluid regulator 113 to the print head base 130 such that the ink outlet 112 of the regulator is oriented in a generally horizontal and/or generally vertical direction. As the regulator is fully operative when submerged within an ink source or outside of an ink source, the general orientation of the regulator is arbitrary.

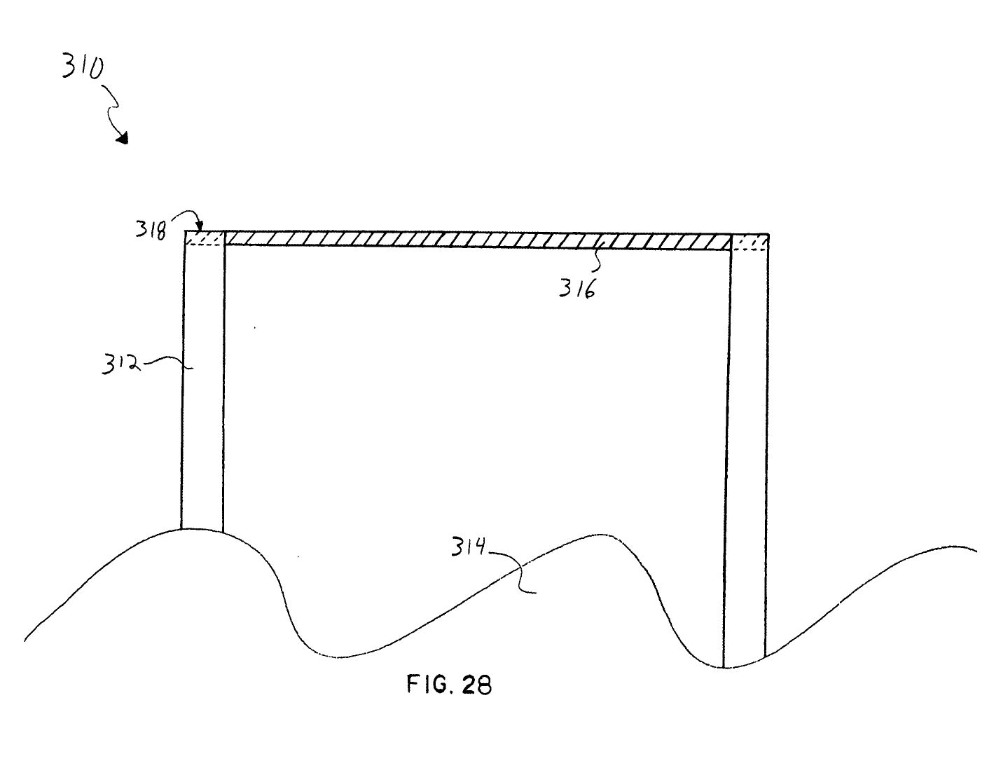

As shown in FIG. 28, an exemplary embodiment 310 includes a standpipe 312 of a printhead base 314 having an ink filter 316 mounted thereto. In a first exemplary process, the ink filter 316 is positioned on the top circumferential surface 318 of the standpipe 312. The ink filter 316 may be comprised of a composite and/or a polymer material and includes a plurality of openings therein to inhibit particulate matter of 12 microns or larger from passing therethrough. The standpipe 312 may generally be comprised of a polymer material acting as a conduit to direct the ink into a plurality of smaller conduits in fluid communication with a plurality of inkjet nozzles (not shown).

A laser emanating from a laser welding apparatus (not shown) outlines a pattern on the top circumferential surface 318 of the standpipe 312. If the ink filter 316 is comprised of a translucent material, laser light will pass through the ink filter 316 and be absorbed by the standpipe 312 material lying underneath. A translucent or transparent material includes any material allowing laser light to pass therethrough without an appreciable amount of such light being absorbed. In this exemplary embodiment, the standpipe 312 material may be comprised of an opaque polymer material that absorbs laser light and becomes viscous from absorption of such light. The viscous nature of the standpipe 312 material approximate the top circumferential surface 318 allows the ink filter 316 to be pushed into the wall of the standpipe 312 to form a wetting ring upon solidification of the standpipe 312 material. A wetting ring generally refers to the appearance of standpipe 312 material permeating the ink filter to a sufficient degree that a fluidic seal is created between the standpipe 312 and the ink filter 316. Those of ordinary skill are familiar with the techniques for pushing the ink filter 316 into the viscous material of the standpipe 312 such as, without limitation, using a ram and/or vacuum forming techniques.

In an alternate exemplary embodiment, the ink filter 316 is comprised of a composite and/or a high temperature polymer absorbing laser light. In this alternate exemplary embodiment, the standpipe 312 material may be comprised of a transparent polymer material. A laser emanating from a laser welding apparatus outlines a pattern on the top circumferential surface 318 of the standpipe 312. The ink filter 316 becomes elevated in temperature from the resulting absorption of laser light shown thereon. Portions of the top circumferential surface 318 of the standpipe 312 become viscous as a result of heat transfer between the ink filter 314 and the standpipe 312. The viscous nature of the standpipe 312 material approximate the ink filter 316 allows the ink filter 316 to be pushed into the top circumferential surface 318 of the standpipe 312 to form a wetting ring upon solidification of the standpipe 322 material. Those of ordinary skill are familiar with the techniques for pushing the ink filter 316 into the standpipe 312 as discussed above.

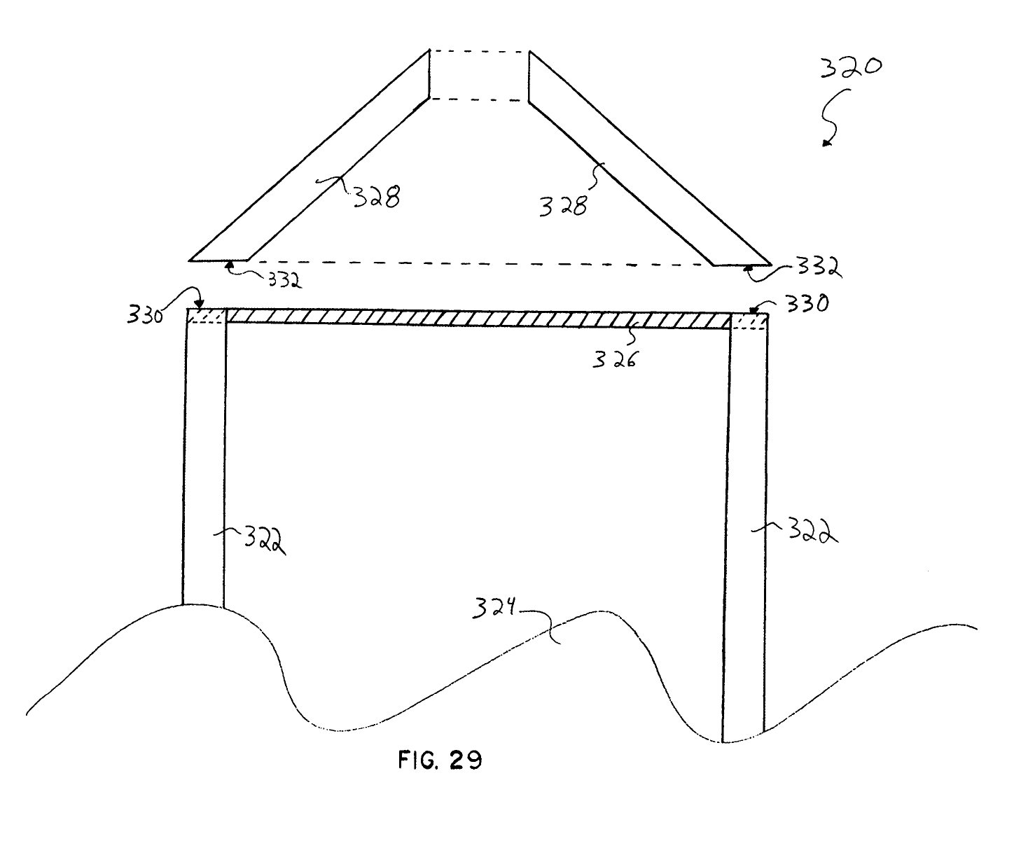

As shown in FIG. 29, another exemplary embodiment 320 includes a standpipe 322 of a printhead base 324 having an ink filter 326 mounted thereto. An ink filter cap 328 is aligned over the standpipe 322 and thereafter mounted to the standpipe 322 by laser welding. In this exemplary embodiment, the ink filter 326 may be mounted to the standpipe as discussed in the first exemplary embodiment and is not dependent upon the materials selected for the ink filter 326. In this exemplary embodiment, the ink filter cap 328 is a translucent material and is positioned to circumscribe a circumferential surface 330 of the standpipe to create a fluidic seal therebetween upon completion of the laser welding process. In summary, the laser emanating from the laser welding apparatus is oriented to outline the circumferential surface 330 of the standpipe, with the laser passing through the filter cap 328 and being absorbed the opaque standpipe 322 material underneath. The absorption of laser light renders viscous a portion of the top circumferential surface 330 the standpipe 322 coming into contact with an underneath surface 332 of the ink filter cap 328. In addition, heat transfer from the viscous standpipe 322 material may cause the underneath surface 332 of the ink filter cap 328 to likewise become viscous. A ram or other mechanical apparatus forces the underneath surface 332 of the ink filter cap 328 into direct contact with the top circumferential surface 330 of the standpipe 322. Upon cooling of the standpipe 322 material, and if applicable the ink filter cap 328 material, a fluidic seal is attained between the underneath surface 332 of the ink filter cap 328 and the top circumferential surface 330 of the standpipe 322.

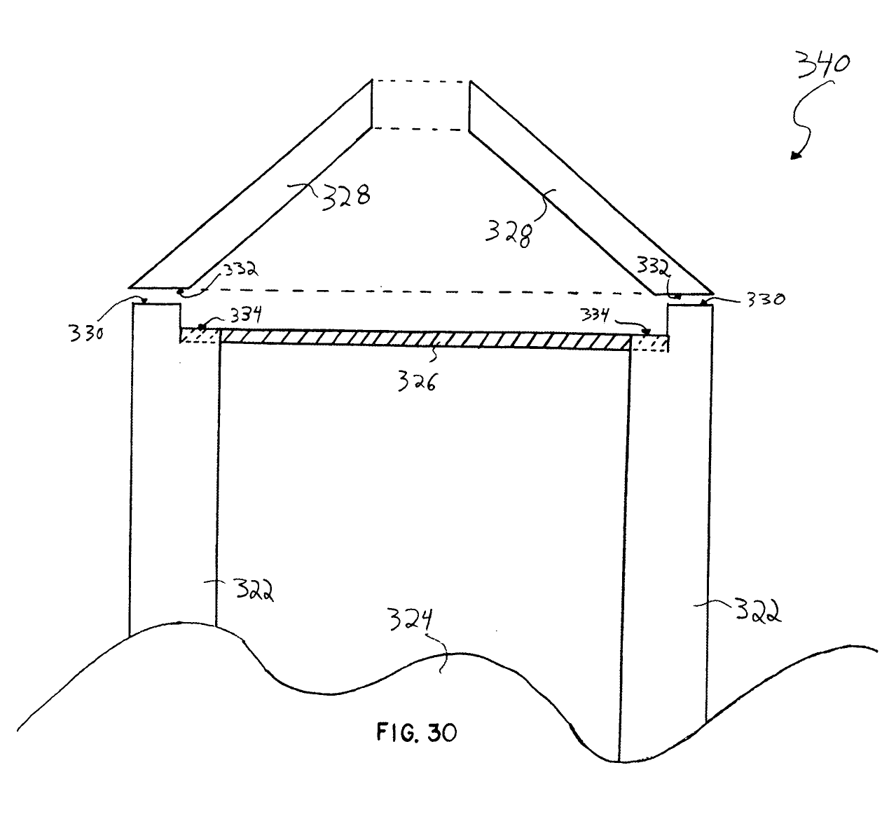

Referencing FIG. 30, an alternate exemplary embodiment 340 also includes the standpipe 322 of the printhead base 324 having the ink filter 326 mounted to an inner circumferential shoulder 334 that is recessed below the top circumferential surface 330 of the standpipe 322. As discussed above, the ink filter 326 may be mounted to the shoulder 334 in accordance with the techniques of the exemplary embodiments discussed above.

The ink filter cap 328 is aligned over the standpipe 322 and thereafter mounted to the standpipe 322 by laser welding. In this alternate exemplary embodiment, the ink filter cap 328 is a translucent material and is positioned to circumscribe the upper circumferential surface 330 of the standpipe 322. The laser emanating from the laser welding apparatus is oriented to outline the circumferential surface 330 of the standpipe 322, with the laser passing through the filter cap 328 and being absorbed by a portion of the circumferential surface 330 of the standpipe 322 underneath. The absorption of laser light renders viscous at least a portion of circumferential surface 330 material coming into contact with the underneath surface 332 of the ink filter cap 328. As discussed above, heat transfer from the viscous standpipe 322 material may cause the underneath surface 332 of the ink filter cap 328 to become viscous. A ram or other mechanical apparatus forces the underneath surface 332 of the ink filter cap 328 into direct contact with the viscous material of the top circumferential surface 330 of the standpipe 322. Upon cooling of the standpipe 322 material, and if applicable the ink filter cap 328 material, a fluidic seal is attained between the underneath surface 332 of the ink filter cap 328 and the top circumferential surface 330 of the standpipe 322. It is advantageous for the ram or other mechanical apparatus to contact a “cool” surface of the ink filter cap 328 to apply a force without fear of concurrently bonding the ram or other mechanical apparatus to the standpipe 322 or ink filter cap 328.

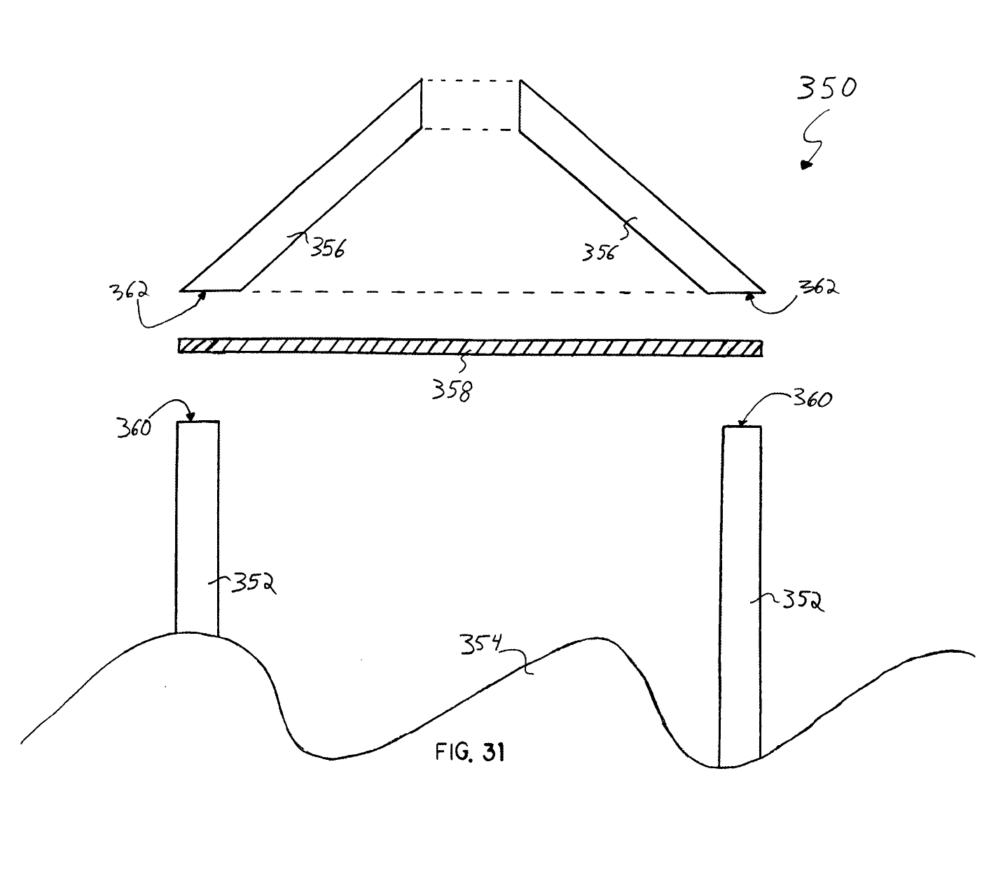

Regarding FIG. 31, a further exemplary embodiment 350 includes a standpipe 352 of a printhead base 354, an ink filter cap 356, and an ink filter 358. In this exemplary embodiment, the ink filter cap 356, the ink filter 358 and the standpipe 352 are simultaneously mounted to one another. The ink filter 358 is aligned on a top circumferential surface 360 of the standpipe. Likewise, the ink filter cap 356 is aligned with the top circumferential surface 360 of the standpipe to 356. Thereafter, a laser emanating from a laser welding apparatus is oriented to define a circumferential pattern corresponding to an outline of the top circumferential surface 360 of the standpipe 352. A force is applied to the ink filter cap 356, the ink filter 358, and standpipe 352 to compress the members together and drive the viscous material of the standpipe 342 through the ink filter 358 and abutting an underneath surface 362 of the ink filter cap 346. As discussed above, the heat transfer from the ink filter 358 and/or the standpipe 352 may cause a portion of an underneath surface 362 of the ink filter cap to become viscous. Upon cooling of the standpipe 352 material, the ink filter 358, and the ink filter cap 356, a fluidic seal is created therebetween.

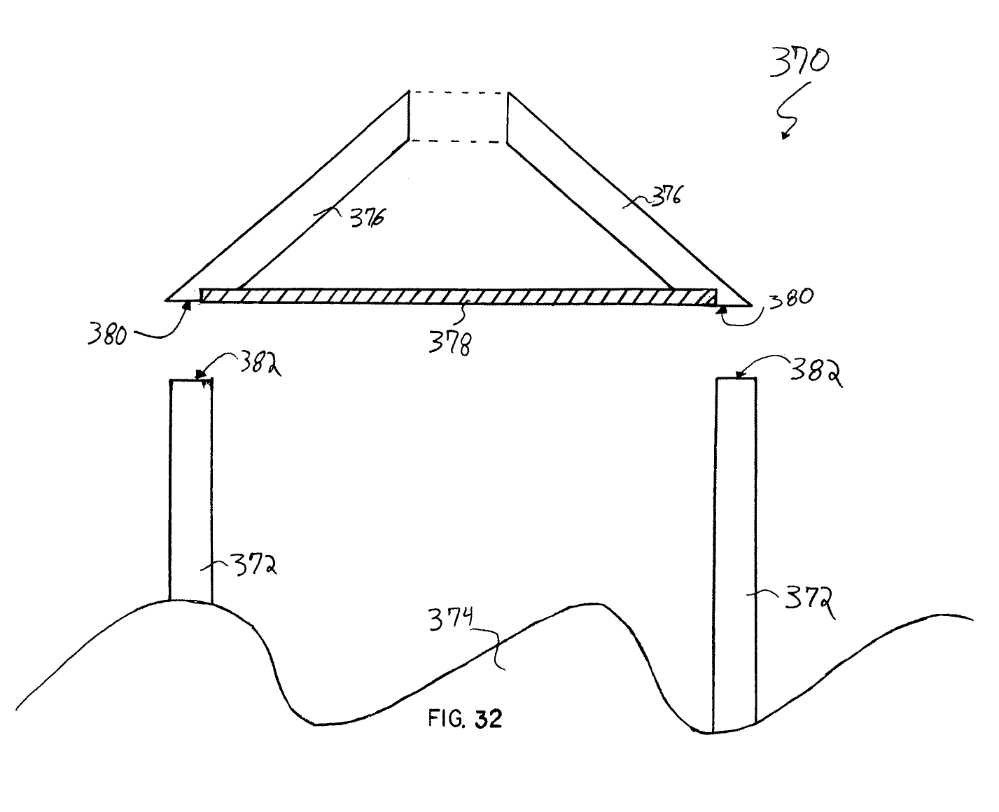

Referencing FIG. 32, an even further exemplary embodiment 370 includes a standpipe 372 of a printhead base 374, an ink filter cap 376, and an ink filter 378. In this exemplary embodiment, the ink filter 378 is mounted to the ink filter cap 376 prior to the ink filter cap 376 being mounted to the standpipe 372. In a first exemplary step, the ink filter 378 is aligned with respect to an underneath surface 380 of the ink filter cap 376. In its aligned position, the ink filter 378 ensures that upon being mounted to the ink filter cap 376, any ink passing through the ink filter cap 376 must likewise pass through the ink filter 378 before entering the standpipe 372. Methods for attaching a polymer, metal, or composite filter 378 to a filter cap 376 are generally known to those of ordinary skill and include heat staking and ultrasonic welding.

A laser welding process is utilized to mount the ink filter cap 370 onto the standpipe 372. In such an exemplary embodiment, it is envisioned that the ink filter cap 376 comprises a transparent material, while the ink filter 378 may be either transparent or opaque. Laser light emanating from the laser welding apparatus is directed through the ink filter cap 376 and absorbed by at least one of the ink filter 378 and the standpipe 372. Absorption of laser light results in at least one of the ink filter 378 and the standpipe 372 increasing in temperature approximate the points of absorption. Radiant and conductive heat transfer result in a portion of the top circumferential surface 382 of the standpipe 372 and/or a portion of the underneath surface 380 of the ink filter cap 376 becoming viscous. Thereafter the viscous material is allowed to solidify to provide a fluidic seal between the ink filter cap 376 and the standpipe 372.

It is likewise within the scope and spirit of the present invention to provide an oversized ink filter dimensioned to have a cross-sectional area substantially greater than the circumferential opening of the standpipe. In this matter, the precise alignment of the ink filter with respect to the standpipe is not critical as substantial leeway is provided, so long as the circumferential opening of the standpipe is covered and eventually sealed to the ink filter.

As discussed and shown with respect to FIGS. 28-32, the laser welded joints are generally flat and do not include a trap or relief area designed to accommodate viscous material flow to potentially fill voids in the joints. In furtherance of providing an area for the viscous material to occupy to create a fluidic seal between the components, relief areas were devised on one or more sides adjacent to the welded area. These traps (or relief areas), as discussed below, may reduce distortion of the components being welded and may be advantageous for directing the flow of viscous material along the length of the joint to fill in any gaps that otherwise might cause a seal failure.

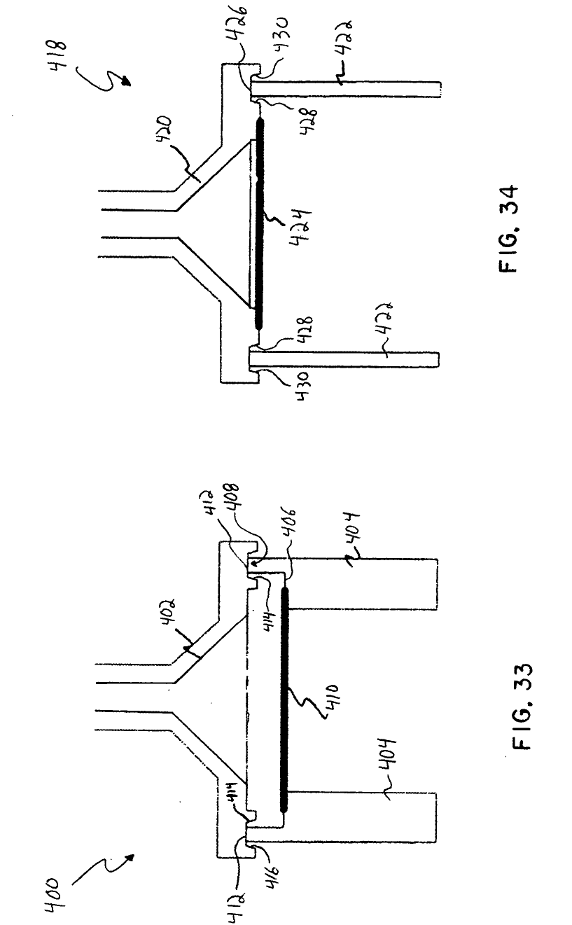

Referencing FIG. 33, a further exemplary embodiment 400 includes an ink filter cap 402 lowered onto a standpipe 404 of a printhead base (not shown). The standpipe 404 includes a ledge 406 circumferentially recessed from the top 408 of the standpipe wall. An ink filter 410 may be mounted to the ledge 406 using heat staking, impulse sealing, or other methods known to those of ordinary skill. It is likewise within the scope of the invention to laser weld the ink filter 410 to the standpipe ledge 406. Laser welding is utilized, at least in part, to mount the filter cap 402 to the standpipe 404 at a joint 412. Upon commencement and during the laser welding procedure, viscous material is produced at the joint 412 and at least some of this material may tend to flow from the joint 412. Such viscous material may come into contact with either an inside tapered wall 414 or an outside tapered wall 416 of the filter cap 402 prior to cooling and solidification. The tapered nature of the walls 414, 416 provide a tapered spacing between the joint 412 and the walls 414, 416 indicative of a tapered trap.

Referring to FIG. 34, still another exemplary embodiment 418 includes an ink filter cap 420 lowered onto a standpipe 422 of a printhead base (not shown). An ink filter 424 may be mounted to the filter cap 420 using heat staking, impulse sealing, or other methods known to those of ordinary skill. It is likewise within the scope of the invention to laser weld the ink filter 424 to the filter cap 420. Laser welding is utilized, at least in part, to mount the filter cap 420 to the standpipe 422 at a joint 426. As discussed above, viscous material resulting from application of the laser in proximity to the joint 426 may result in material coming into contact with either an inside tapered wall 428 or an outside tapered wall 430 of the filter cap 420. The tapered nature of the walls 428, 430 provide a tapered spacing between the joint 426 and the walls 428, 430 indicative of a tapered trap.

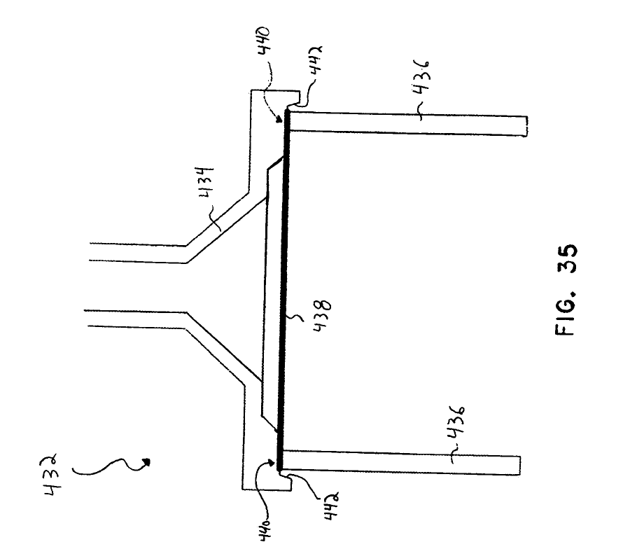

Referring to FIG. 35, still a further exemplary embodiment 432 includes an ink filter cap 434 and a standpipe 436 of a printhead base (not shown) sandwiching an ink filter 438 therebetween. Laser welding is utilized, at least in part, to concurrently mount the filter cap 434, the ink filter 438, and the standpipe 436 together at a joint 440. Viscous material flowing from the joint 440 may come into contact with an outside tapered wall 442 of the filter cap 434. The tapered nature of the wall 442 provides a tapered spacing between the joint 426 and the wall 442 indicative of a tapered trap.

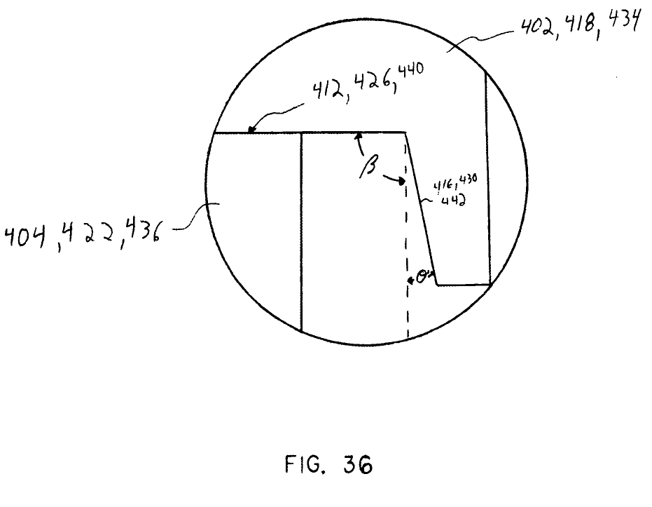

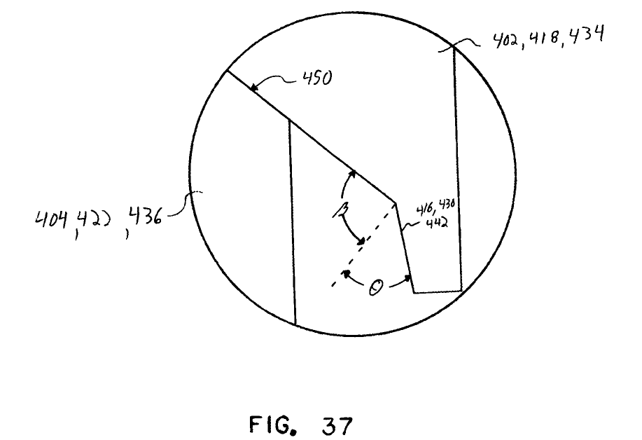

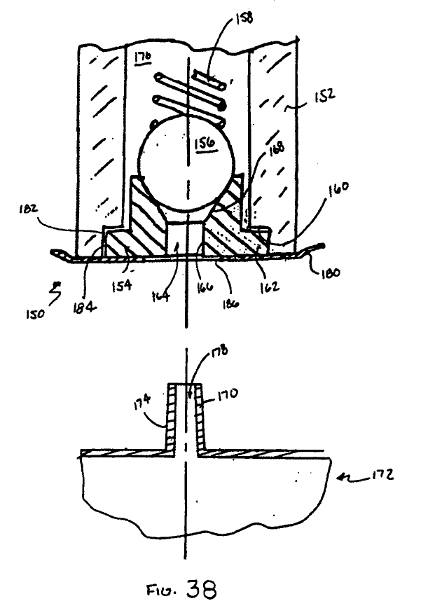

Referencing FIGS. 36 and 37, exemplary tapered trap angles include wall angles over 5 degrees, as represented by θ, from a 90 degree perpendicular offset, as represented by β. FIG. 37 shows an exemplary embodiment where the welded joint 450 is not horizontal and thus, θ is substantially greater than 5 degrees. Preferred angles (θ) include from 5 to 30 degrees from perpendicular offset for a horizontal welded joint. In this manner the width of the trap at the top will be narrower than the width of the trap at the bottom or farthest away from the weld area. Exemplary measurements for a tapered trap in accordance with the principles of the present invention include a 0.05 mm to 0.5 mm spacing between the wall 404, 422, 436 adjacent to the welded area and the tapered portion 416, 430, 442 of the filter cap, while a greater than 0.05 mm to 0.5 mm spacing may be present between the wall 404, 422, 436 and the tapered portion 416, 430, 442 of the filter cap farthest from the welded area.

While square traps have been successfully utilized and are within the scope of the invention, it has been discovered that tapered traps may have certain advantages in creating resistance to viscous material flow soon after the material has been displaced from the welded area and to direct the flow along the length of the joint for a given geometry. However, too much resistance to flow may result in a particular area “plugging” and resulting in viscous material flow in undesired locations. Therefore, a tapered trap may provide the requisite resistance to viscous material flow along the length of the joint and decreases the likelihood of “plugging” for a given geometry.

It is also within the scope of the present invention to provide with traps, and in particular tapered traps, in proximity to welded joints of other components other than those referred to in the exemplary embodiments above. For example, a tapered trap might be provided to mount a lid onto a printhead body. Those of ordinary skill will readily realize the applicability of traps in proximity to laser welded joints.

As shown in FIG. 38, a seal and interface system 150 for the stem 152 of a replaceable ink tank includes a septum 154, a ball (check) 156 and a check spring 158. The ink tank stem 152 includes an annular shoulder 160 for seating the annular flange 162 of the septum such that the bottom surfaces of the ink tank stem and septum are flush with one another. The septum includes an axial ink channel 164 extending there through. The ink channel 164 includes a lower cylindrical portion 166 and an upper frustoconical portion 168 that has a diameter that widens with the distance from the lower cylindrical portion 166. The shape of the upper frustoconical portion 168 allows the ball 156 to be seated therein and the bias applied by the spring 158 against the ball 156 causes the ball 156 to form a seal against the frustoconical portion 168 of the ink channel 164. The seal and interface system 150 is adapted to mate with a needle 170 of a print head assembly 172. The needle 170 extends through the cylindrical portion 166 of the channel 164, thus contacting and displacing the ball 156 from the frustoconical portion 168 of the septum. The needle 170 surface contacting and displacing the ball 156 includes variable height features that allow ink to flow into the needle 170 and into the print head assembly 172 as the ball 156 is displaced. Simultaneously, as the seal between the ball 156 and the septum 154 is broken, the outer circumferential portion of the needle 170 is such that it forms a seal between the outer surface 174 of the needle and the inner surface of the lower cylindrical portion 166 of the septum's ink channel 166. When coupled in such a manner, ink is permitted to flow from the ink reservoir 166 within the ink tank stem 152 through the ink channel 164 of the septum and through the inlet channel 178 of the needle 170 into the print head assembly 172. When the replaceable ink tank is removed again from the print head assembly, the needle 170 is removed again from the ink channel 164 of the septum 154 allowing the check spring 158 to push the ball 156 back into a sealing engagement with the frustoconical portion 168 of the ink channel.

According to an embodiment of the present invention, the film 180 is sealed to both the bottom surface of the ink tank stem 152 and the bottom surface of the septum 154, so as to effectively provide an annular seal between the inner circumferential surface 182 of the ink tank stem and the outer circumferential surface 184 of the septum. In the exemplary embodiment, the film 180 is heat-sealed to both the bottom surface of the ink stem 152 and the bottom surface of the septum 154. Both heat seals circumscribe the ink channel 164. To allow for such a heat-seal bond, the septum, ink tank stem and film materials are selected such that the film material is heat sealable to both the septum material and the ink tank stem material. In the exemplary embodiment, the film 180 also includes a hole 186 extending there through that is axially aligned with the ink channel 164 of the septum and having a diameter larger than that of the lower cylindrical portion 166 of the ink channel 164. In this exemplary embodiment, the ink tank stem 152, the septum 154, the ink channel 164, and the needle 170 may also have a non-circular cross-section.

Assembly of the seal and interface system 150 may be accomplished by heat-sealing the film 180 to the lower surface of the septum 154, stacking the various components within the ink tank stem 152 and then heat-sealing the film 180 extending radially from the septum 154 against the lower surface of the ink tank stem 152. This construction process is advantageous in a situation in which the lower surfaces of the septum 154 and ink tank stem 152 are not flush, having stepwise offsets. It is also within the scope of the invention to allow for simultaneous heat-welding of the film to both the ink tank stem 152 and septum 154. The hole 186 may be punched into the film 180 prior to construction, prior to attachment of the septum, or even after all components are assembled. In addition to heat-welding the film 180 to the ink stem 152 and/or the septum 154, laser welding can be used to provide sufficient seals. Laser welding is also advantageous in the embodiment in which the film 180 is replaced with a thicker cap of material. In such an embodiment, the cap material should have a certain level of laser light transparency to allow laser light to pass through, and the base materials being bonded thereto need to absorb the laser energy through the laser light transparent cap.

In the exemplary embodiment of FIG. 38, many materials for the various components have been used and tested. The materials of the ink stem 152 and/or septum 154 may generally be a polyolefin-like polypropylene (PP), polyethylene (PE), or a blend of such materials. The film 180 may have at least one layer of polypropylene or various grades of polyethylene. The films may be single layered or multi-layered, where the multi-layer of films may include layers of nylon and/or polyester to provide additional strength and toughness. In a specific embodiment, the septum 154 material was molded Santoprene, which is a polypropylene-based thermoplastic elastomeric (TPE) material. Kraton and other TPE materials, as well as ethylene-propylene-diene-monomer (EPDM) synthetic rubbers may also be suitable for sealing to PE and/or PP based materials. EPDM does not remelt like the TPE materials, but a number of molded grades of EPDM have been found to bond to the film well enough to create a fluidic seal for the present application. Additionally, EPDM has a reduced level of compression set that certain TPE materials have. It is also within the scope of the invention to select a single or multi-layer film in a manner to control the permeation properties of the septum area. The transfer of penetrants such as oxygen in water vapor as well as a wide variety of others could be controlled through this selection. Materials chosen for this purpose could include, but are not limited to, nylons, polyesters, polyolefins, metallization, ethylene vinyl alcohol (EVOH), or metal foils. The seal created between the film and the septum material would allow the barrier properties of the film to apply to the entire film seal area. This barrier would remain intact even after a needle insertion as opposed to prior art methods where the film is not sealed to the septum.

The present seal approach may also be used for other applications. One such application could be to create a multi-piece flexible diaphragm to replace the control valve disclosed in U.S. Pat. No. 6,394,137, which shows a thin rubber diaphragm attached to a support ring. This could be replaced by attaching the central seal region to the film by one of the above methods described, and then attaching the diaphragm to the tank without needing an extra support ring. U.S. Pat. No. 6,383,436 shows a method of insert molding a TPE material onto a ring to form the backpressure control member. As can be seen, this also has a seal member attached to the film for a seal and a film attached to the body or support member for the second portion of the seal. The embodiment of the seal and inlet system as shown and described above in FIG. 28, is advantageous over several known seal and interface systems for use in replaceable ink tanks. One such prior art seal and interface system for use in replaceable ink tanks utilizes a crimp ring to crimp the septum and ink tank stem together, where the crimp ring attaches to an annular collar extending from the ink tank stem. To perform the crimping operation, a number of requirements are placed on the system. The first is that a relatively tall stem with the collar in the mold must be formed. This is more expensive to mold and the stem may break off if the tank is dropped. Although features can be placed on the tank to protect the stem, a great deal of clearance next to the stem is required so that the crimp tool can be used to install the crimp ring. This also means that there may be a substantial distance between multiple stems and a multi-colored tank. The variability and crimp process parameters also may cause a good deal of variation in the final geometry of the septum seal. This variation may affect insertion force, which is maintained as low as possible to improve customer satisfaction. Exemplary applications include on-carrier and off-carrier ink tanks.

Another prior art seal system for use in replaceable ink tanks holds and seals the septum in place with film. The prior art film is continuous without any holes in it. Therefore, during tank insertion, the needle of the print head assembly must first puncture the film before creating the seal with the septum in pushing the check system out of sealing engagement with the septum. Both this prior art system and the embodiment of the present invention disclosed in FIG. 38 allow for placing multiple colors and their connections on the same tank. A single piece of film can then be used to hold all the septums in place. The prior art system, however, utilizes a radial compression seal between the septum and the stem. The film in the prior art assembly provides a redundant seal during shipping until it is later punctured. At that time the only purpose of the film becomes keeping the septum from coming out of the stem. Therefore, with the prior art seal system, the film does not provide an effective seal between the septum and the ink tank stem when the needle punctures through the film. Therefore, the embodiment of the invention disclosed in FIG. 38 does not require the use of a compression seal between the septum and the stem. Furthermore, because the embodiment shown in FIG. 38 provides the various seals using the welding of the film to both the septum and the ink tank stem, the seal system is provided with lower connection force and less tolerance variations as compared to the prior art seal systems. Conventional compression seal geometry is no longer necessitated. Additionally, certain multi-part applications can be performed more efficiently and less costly.

Following from the above description and invention summaries, it should be apparent to those of ordinary skill in the art that, while the methods and apparatuses herein described constitute exemplary embodiments of the present invention, the inventions contained herein are not limited to these precise embodiments and that changes may be made to them without departing from the scope of the inventions as defined by the claims. Additionally, it is to be understood that the invention is defined by the claims and it is not intended that any limitations or elements describing the exemplary embodiments set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A method of assembling an ink filtration system in fluid communication with an ink source comprising the steps of:
providing a printhead base including at least one ink channel in fluid communication with at least one nozzle;
positioning an ink filter in fluid communication with at least the one ink channel of the printhead base; and
laser welding the ink filter in series with the printhead base to provide a sealed fluidic interface therebetween ensuring that ink within at least the one ink channel has passed through the ink filter.

2. The method of claim 1, wherein the ink filter includes a transparent polymer material.

3. The method of claim 1, wherein the ink filter includes an opaque polymer material.

4. The method of claim 1, wherein the ink filter includes a metal.

5. The method of claim 1, wherein the metal includes stainless steel.

6. The method of claim 1, wherein the printhead base includes a standpipe to which the ink filter is mounted thereto.

7. The method of claim 1, further comprising the step of laser welding an ink filter cap onto the printhead base.

8. The method of claim 7, wherein the ink filter is between the ink filter cap and the printhead base.

9. A method of assembling components of an ink filtration system adapted to be associated with an inkjet printer, comprising the steps of:
providing a printhead base having at least one ink channel in fluid communication with at least one nozzle;
providing an ink filter cap;
providing an ink filter interposing the printhead base and the ink filter cap; and
laser welding at least one of the printhead base, the ink filter cap, and the ink filter to at least another of the printhead base, the ink filter cap, and the ink filter to provide a sealed fluidic laser welded joint therebetween.

10. The method of claim 9, further comprising the step of aligning the ink filter with respect to an orifice in the ink filter cap.

11. The method of claim 9, further comprising the step of aligning the ink filter with respect to an orifice in a standpipe of the printhead base.

12. The method of claim 9, wherein the ink filter comprises a transparent polymer material.

13. The method of claim 9, further comprising an ink flow regulator mounted to the ink filter cap.

14. The method of claim 9, wherein the ink filter comprises an opaque polymer material.

15. The method of claim 9, wherein the ink filter comprises a metal.

16. The method of claim 9, wherein metal includes stainless steel.

17. The method of claim 9, wherein the ink filter is mounted to the printhead base in an earlier step, and the ink filter cap is laser welded to the printhead base in a later step.

18. The method of claim 9, wherein the ink filter is mounted to the ink filter cap in an earlier step, and the ink filter cap is laser welded to the printhead base in a later step.

19. The method of claim 9, wherein the ink filter is laser welded to the ink filter cap in an earlier step, and the ink filter cap is mounted to the printhead base in a later step.

20. The method of claim 9, wherein the ink filter is laser welded to the printhead base in an earlier step, and the ink filter cap is mounted to the printhead base in a later step.

21. The method of claim 9, wherein the ink filter is laser welded to the printhead base in an earlier step, and the ink filter cap is laser welded to the printhead base in a later step.

22. The method of claim 9, wherein the ink filter is laser welded to the ink filter cap in an earlier step, and the ink filter cap is laser welded to the printhead base in a later step.

23. The method of claim 9, wherein the ink filter, the ink filter cap, and the printhead base are mounted together in a single laser welding step.

24. An ink cartridge comprising:
a printhead base comprising a heater chip, the plurality of nozzles, and a TAB circuit;
a container adapted to house a reservoir of ink therein, the container having a conduit directing ink within the reservoir toward the plurality of nozzles associated with the printhead base; and
an ink filter laser welded to the container conduit to inhibit particulate debris from entering the conduit.

25. The ink cartridge of claim 24, further comprising an ink filter cap mounted to the container conduit.

26. The ink cartridge of claim 25, wherein the ink filter is positioned between the container conduit and the ink filter cap.

27. A method of assembling components of an ink regulation and filtration system for an inkjet printer comprising the steps of:
providing a printhead base having at least one ink channel in fluid communication with at least one nozzle;
providing an ink filter in fluid communication with at least the one ink channel of the printhead base;
providing an ink flow regulator in fluid communication with at least the one ink channel; and
laser welding at least two of the printhead base, the ink filter, an ink filter cap, and the ink flow regulator together to provide a sealed fluidic interface and ensure that ink within at least the one ink channel has passed through the ink filter before reaching at least the one nozzle.

28. The method of claim 27, wherein the ink filter is laser welded to the printhead base.

29. The method of claim 27, wherein the ink filter cap is laser welded to the printhead base.

30. The method of claim 27, wherein the ink filter cap is laser welded to the ink filter.

31. The method of claim 27, wherein the ink filter cap and ink filter are laser welded to the printhead base.

32. A method of mounting an ink filter in fluid communication with a plurality of nozzles associated with a printhead base comprising the step of:
providing a sealed fluidic conduit between a source of ink and a channel in fluid communication with a nozzle of a printhead base, the sealed fluidic conduit includes an ink flow regulator, an ink filter, and an ink filter cap, wherein at least one of the ink flow regulator, the ink filter, and the ink filter cap are laser welded to provide the sealed fluidic conduit between the source of ink and the channel in fluid communication with the nozzle of the printhead base.

33. A method of mounting components of an inkjet printer cartridge comprising the steps of:
mounting an ink filter to a standpipe of a printhead base; and
mounting an ink filter cap to the standpipe of the printhead base.

34. The method of claim 33, wherein the mounting steps occur concurrently.

35. The method of claim 33, wherein the ink filter is laser welded to the standpipe of the printhead base.

36. The method of claim 33, wherein the ink filter is laser welded to the ink filter cap.

37. The method of claim 33, wherein the ink filter is mounted to an inner circumferential ledge of the standpipe that is recessed from an upper circumferential surface onto which the ink filter cap is mounted to the standpipe.

38. The method of claim 37, wherein the ink filter cap is laser welded to the upper circumferential surface of the standpipe.

39. The method of claim 37, wherein the ink filter is laser welded to the inner circumferential ledge of the standpipe.

40. A method of mounting components of an inkjet cartridge using a laser welding apparatus, wherein the method includes at least one step from the group consisting of laser welding an ink filter to a printhead base, laser welding an ink filter cap to an ink filter, laser welding an ink filter cap to a printhead base, laser welding an ink filter to an ink flow regulator, laser welding an ink filter cap to an ink flow regulator, laser welding an ink flow regulator to a printhead base, laser welding an ink flow regulator to an ink reservoir conduit, and laser welding an ink filter cap to an ink reservoir conduit.

41. A method of accommodating viscous material flow from a laser welded joint comprising the step of:
providing a cavity in proximity to a joint into which viscous material resulting from a laser welding process may flow, the cavity being bounded in part by an angled surface not parallel to the direction of flow of the viscous material, wherein the joint lies on a first plane and the angle between the first plane and the angled surface is greater than 90 degrees.

42. A method of accommodating viscous material flow from a laser welded joint comprising the step of:
providing a trap available for a viscous material generated from a laser welding process to flow into, the laser welding process mounting at least two components together to form a joint lying on a first plane, wherein a first cross-sectional area of the trap taken along the first plane is less than a second cross-sectional area attributable to a second cross-section taken along a second plane spaced and parallel to the first plane.

43. A method of accommodating viscous material flow from a laser welded joint comprising the step of:
providing a cavity in proximity to a joint between a first component and a second component to accommodate a flow of a viscous material from the joint during a laser welding procedure to mount the first component to the second component, the cavity defined in part by a tapered flange unevenly spaced from an opposing wall, wherein the opposing wall is a constituent of a first component and the tapered flange is a constitute of a second component.

44. A method of accommodating viscous material flow from a laser welded joint comprising the step of:
providing an ink filter cap having a flange at least partially circumscribing an outer wall of a standpipe, the ink filter cap contacting the standpipe to form an interface therebetween, the flange being separated from the outer wall of the standpipe to leave a gap into which viscous material may flow from the interface upon application of a laser the interface, wherein the flange generally includes an angled wall facing the outer wall of the standpipe, and wherein the distance between the angled wall and the outer wall of the standpipe increases concurrently as the distance between the interface and the angled wall increases.
